(19) United States
(12) Patent Application Publication
(10) Pub. No.: US 2010/0109999 A1
(43) Pub. Date: May 6, 2010

(54) HUMAN COMPUTER INTERACTION DEVICE, ELECTRONIC DEVICE AND HUMAN COMPUTER INTERACTION METHOD

(76) Inventor: Bo Qui, Wuxi (CN)

Correspondence Address: SCHMEISER, OLSEN & WATTS, 22 CENTURY HILL DRIVE, SUITE 302, LATHAM, NY, 12110, US

(21) Appl. No.: 12/520,181

(22) PCT Filed: Dec. 19, 2007
(86) PCT No.: PCT/CN07/03670

§ 371 Date: Dec. 3, 2009

(30) Foreign Application Priority Data
Dec. 19, 2006 (CN) 200610171339.3
Mar. 12, 2007 (CN) 200710086457.9
May 8, 2007 (CN) 200710104347.0
May 25, 2007 (CN) 200710107261.3
Sep. 6, 2007 (CN) 200710147366.1

(51) Int. Cl. G09G 5/00

(52) U.S. Cl. 345/156

(57) ABSTRACT

A human computer interaction device includes a first input device and a second input device, and there are at least a part of the operation regions of the whole function or a certain function of the second input device locating in the key operation region of the first input device. The first input device could be a key-input device and the second input device could be a mouse simulation device. An electronic device and a human computer interaction method using the human computer interaction device are further provided. This invention can reduce the operating regions of both the key input device and the mouse function, and can realize the key input device and mouse function without moving the forearm, thus increasing the work efficiency.

### FIELD OF THE INVENTION

The present invention relates to the human computer interaction field, particularly relates to a human computer interaction device, electronic device and human computer interaction method.

### BACKGROUND OF THE INVENTION

In current society, computers are extensively used in all fields. Computer auxiliary devices are an indispensable part of a computer, and human computer interaction devices are the major computer auxiliary devices during the process of human-computer interaction, such as keyboards, mice and writing boards, and so on.

In prior arts, keyboards include the following two types:

Hard keyboard, including external keyboards, such as the ordinary external keyboard of a desktop computer; the keyboards integrated with a host, such as the keyboards integrated with the host of a laptop computer or a palmtop computer, and special keyboards, such as the special keyboards for numerical control equipment, cash registers and other applications, and so on.

Soft keyboard, which is a keyboard figure displayed on the screen, can realize information input by means of a mouse or by touching. Functioning as a displayable input device, the soft keyboard can be used on portable devices, control consoles or control panels and other electronic devices.

In prior arts, the devices for realizing mouse function include the following four types:

External mouse, such as commonly-used wheel mice or optic mice;

External track ball, a kind of input devices similar to a mouse, through turning the track ball directly with hand, cursor's movement being realized, in addition, a button or buttons being set to realize the same functions as mouse's left/right button;

Touch pad or touch screen, a touch input or output device; touch pad, such as the touch pad mouse, being used widely for laptop computers, which is located below the host keyboard. To use touch pad is very simple: just touching with fingers the touch pad located below the keyboard can make the cursor move; tapping the surface of the touch pad will be identified as single-click or double-click of mouse or other corresponding mouse operations.

The track point, invented by IBM Corp and now being commonly used for IBM laptop computers. It has a small button located among the keys G, B, H on the keyboard, and two large buttons below the blank key. The small button can respond to the magnitude and direction of finger's thrust force, thus controlling the mouse trajectory; the large buttons below are equivalent to the left button and right button of a standard mouse.

In prior arts, the writing boards include the following two types:

External writing board, externally connected with computers and providing Chinese characters and graphics input;

Composite writing board, integrated with a touch pad and functioning as a writing board to input Chinese characters and graphics on the touch pad.

Among the above three commonly-used human-computer input devices, the application portfolio of keyboard and mouse in computers is mainly divided into the following methods, while the writing board can be externally connected with the host or the function of the writing board can be realized by a touch pad.

Method I: External Connection of the Host with a Mouse

This method relates to desktop and laptop computers (some people also connect the mouse with their laptop computer by force of habit).

Its advantage is the flexible and convenient use of the mouse; and its disadvantage is frequent movement of forearm due to the separation of the keyboard from the mouse (or the writing board), with low working efficiency and inconvenient carrying.

Method II: Both of the Devices Used for Realizing the Mouse Function and the Keyboard are Fixed on the Host

Such method is commonly used in laptop computers. The first way is to provide a touch pad below the fixed keyboard of a laptop computer, but its disadvantage is that the forearm has to be moved frequently during the operation process because of a certain distance between the keyboard and the touch pad, thus resulting in low working efficiency. The second way is to provide both a track point on the fixed keyboard of a laptop computer and two large buttons below the blank key, but its disadvantage is that the forearm has to move frequently due to a certain distance between the two large buttons and the keyboard, thus resulting in low working efficiency.

### SUMMARY OF THE INVENTION

To solve technical problems, the invention creates a human computer interaction device, electronic device, and a human computer interaction method, which reduce the zone of the operation of both key-input and mouse function, and both key-input and mouse function are realized without moving forearm so as to increase efficiency.

To solve the foresaid problems, the invention provides a human computer interaction device, comprising a first input device and a second input device, which is characterized in that at least part of the operating regions of a certain function or all functions of the said second input device is located within the key operating region of the said first input device;

or,
a human computer interaction device, comprising a second input device or a part thereof and a first input device or a part thereof, wherein within any region of any size at any position including the region or space of the said part of or the whole of the second input device and the said part of or the whole of the first input device, the said part of or the whole of the second input device and the said part of or the whole of the first input device use the same region or space, that is, overlapping or reuse of a part of or a whole of a region or a space;
or,
a human computer interaction device, which is characterized in that it comprises a second input device or a part thereof and a first input device or a part thereof; and the said second input device or a part thereof and the said first input device or a part thereof use the same region or space within any region of any size at any position within a region or space of the said part of or the whole of the second input device and the said part of or the whole of the first input device; namely, a whole or partial overlapping or reuse of a region; and the said regional\spacial\dimentional overlapping or regional\spacial\dimentional reuse is the regional\spacial\dimentional overlapping or regional\spacial\dimentional reuse in the same time or in different time;
or,
at least part of the operating regions of the said second input device is located within the key operating region of the said first input device other than the devices with special/only mouse function or limited function, wherein the devices with limited function mean that the function of the said device are limited or the number of the functions of the said device is limited; the first input device other than the devices with special/only mouse function or limited function may include, but is not limited to, hard devices or soft devices;
or,
a human computer interaction device, which is characterized in that it comprises a second input device used for realizing a mouse function and a first input device, wherein, the region where the said second input device is located should be overlapped at least partially with the region where the first input device is located, and the region where the said first input device is located consists of the region where one or more keys are located, and doesn't include the regions between these input keys;
or,
a human computer interaction device, which is characterized in that it comprises a touch pad, a touch screen or the other hard input device used for realizing a mouse function and a first input device, wherein, the said touch pad, touch screen or the other hard input device are the devices that realize input by means of touching, and moreover, the region where the said touch pad, touch screen or the other hard input device is located is overlapped at least partially with the region where the first input device is located, and the region where the said first input device is located consists of the region where one or more keys are located and the region between these input keys;
or,
a human computer interaction device, which is characterized in that it comprises a second input device used for realizing a mouse function and a soft first input device, wherein, the region where the said second input device is located is overlapped at least partially with the region where the soft first input device is located; the region where the said soft first input device is located consists of the region where one or more input keys are located and the region between these input keys;
or,
a human computer interaction device, which is characterized in that it comprises a second input device used for realizing a mouse function and a first soft input device;
or,
all of the first input devices said above can be replaced with an input device, wherein the input device includes a key input device or key input devices.

Further, the following can also be the characteristic of the foresaid human computer interaction device:

the said regional\spacial\dimentional overlapping or regional\spacial\dimentional reuse means the regional\spacial\dimentional overlapping or regional\spacial\dimentional reuse in same time or in different time; or,

the said first input device is a key input device, namely, the device that input can be realized through key operations; the said ‘key’ includes one or more types as follows: the formal, hidden, invisible or visible keys, buttons, icons, menu items, commands, command configurations, display modes, knobs or the commands or graphic representations that can be operated by clicks, the figures similar to the input and/or output devices on the keyboard or the control panel; the formal, hidden, invisible or visible, implicit, explicit or displayed keys, buttons, icons, menu items, commands, command configurations, display modes, knobs or the commands or graphic representations that can be operated by clicks, the figures similar to the input and/or output devices realized or displayed on the keyboard or the control panel by means of software; or,

the said second input device is a mouse simulation device used for realizing a mouse function, and the said mouse function includes, but is not limited to, one or more functions as following: executing, selecting, dragging, displaying menu, moving cursor, scrolling display screen, and multi-dimensional simultaneous moving display;

the said key input device and/or the mouse simulation device include(s) the following types of input devices or input and output devices or their combination, or soft devices realized on input/output devices: electronic whiteboards, whiteboards, projection keyboard devices, touch screens, touch pads, other touch devices, electrical input devices, electromagnetic induction devices, pressure devices, infrared devices, laser devices, and mechanical devices.

Further, the following can also be the characteristic of the foresaid human computer interaction device:

the said mouse simulation device includes the partial or whole surface of at least one key or part of or the whole of a region between keys, and it can be located in an independent region within the key region of the said key input device, or partial said mouse simulation device is located within the key region, and the remaining part is located in the other region;

and/or, regional reuse of the overlapping part between the said mouse simulation device and the said key region can work under at least two modes—a key input mode and a mouse function mode;

and/or, there exists regional overlapping or regional reuse between at least part of the operating region of the said mouse simulation device and the key operating region of the said key input device; namely, the same region can be used for or realize the function of random more different devices.

Further, the following can also be the characteristic of the foresaid human computer interaction device:

the said mouse simulation device includes one or more auxiliary components within or outside the key operating region of the said key input device, and theses auxiliary components are used to realize the whole or part of the mouse function of the human computer interaction device; or, part of the liked mouse function that these auxiliary components are used for realizing, including the functions of ‘displaying menu’ or ‘multi-dimensional simultaneous moving display’.

Further, the following can also be the characteristic of the foresaid human computer interaction device:

on the said human computer interaction device, one or more control switches are also set to turn on or turn off the mouse function; the control switches will be soft or hard control switches, and the regions where the above said switches are located are as follows:

in or near the regions where the first input device or the second input device is located; or,

in the region where the first input device is located and which is overlapped at least partially with the region where the second input device is located; or,

in the region where the soft/hard keyboard-type keyboard of desktop computers, the keyboard-type keyboard of laptop computers, or the keyboard that is more than X cm long, is located, each of which is overlapped at least partially with the region where the second input device is located; wherein X is 8, 10, 12, 14, 16 or 18; or,

in the region Y cm away from the space key of the soft/hard keyboard-type keyboard of desktop computers, the keyboard-type keyboard of laptop computers, or the keyboard that is more than X cm long, each of which is overlapped at least partially with the region where the second input device is located; wherein Y is 1, 3, 5, 7 or 9.

Further, the following can also be the characteristic of the foresaid human computer interaction device:

the said control switch adopts one of or a combination of the following forms: at least one independently-set button, at least one track point, at least one scroll ball, at least one scroll wheel, at least one set of key combination, at least one operating key outside the mouse simulation device region, at least one operation mode customized on the said human computer interaction device.

Further, the following can also be the characteristic of the foresaid human computer interaction device:

the said mouse simulation device includes one or more main simulation devices, and one or more auxiliary components set in or near the key region of the said key input device; the said main simulation device and the said touch device together realize the whole or part of the mouse function of the said human computer interaction device, which at least include the auxiliary component(s) used for realizing the function of cursor movement and the auxiliary component(s) used for realizing mouse's button function;

the said main simulation device may include, but is not limited to, the following types of input devices or input and output devices or their combination: electronic whiteboards, whiteboards, projection keyboard devices, touch screens, touch pads, the other touch devices, electrical input devices, electromagnetic induction devices, pressure devices, infrared devices, laser devices, and mechanical devices.

Further, the following can also be the characteristic of the foresaid human computer interaction device:

the said auxiliary components adopt one of or a combination of the following forms: at least one track point, at least one scroll ball for controlling object's movement, at least one scroll wheel for controlling object's movement, at least one button for confirming an operation or operations, at least one touch device and at least one operating key which can work under the mouse function mode.

Further, the following can also be the characteristic of the foresaid human computer interaction device:

the said key input device is a keyboard; the said mouse simulation device comprises one main simulation device arranged on the left or right side of the said keyboard as well as certain keys arranged on the other side of the keyboard; the said certain keys can be set by selection to comprise one or more keys to which finger(s) will return after pressing a key or keys according to the standard fingering, and they are used to realize mouse's button function; or,

the said key input device is a keyboard; the said mouse simulation device comprises one main simulation device arranged on the said keyboard and certain keys arranged in the key region of the keyboard but out of the said main simulation device; among the said certain keys, the keys operated by left hand according to the standard fingering are used for realizing the function of mouse's left button, and the keys operated by right hand according to the standard fingering are used for realizing the function of mouse's right button;

the said main simulation device may include, but is not limited to, the following types of input devices or input and output devices or their combination: electronic whiteboards, whiteboards, projection keyboard devices, touch screens, touch pads, the other touch devices, electrical input devices, electromagnetic induction devices, pressure devices, infrared devices, laser devices, and mechanical devices.

Further, the following can also be the characteristic of the foresaid human computer interaction device:

the said key input device is a hard keyboard or a control panel; the said mouse simulation device is a hard device; in or near the key region of the said key input device, there are one or more hard control switches used for turning on or turning off the mouse function, or, on the said mouse simulation device, there are soft control switches used for turning on and turning off the mouse function; or,

the said key input device is a soft keyboard or a soft control panel displayed on the human computer interaction device; the said mouse simulation device is a soft device displayed on the human computer interaction device; on the said human computer interaction device, there are one or more hard control switches or soft control switches used for turning on or turning off the mouse function; the said human computer interaction device may include, but is not limited to, the following types of input devices or input and output devices or their combination: electronic whiteboards, whiteboards, projection keyboard devices, touch screens, the touch pads, other touch devices, electrical input devices, electromagnetic induction devices, pressure devices, infrared devices, and laser devices.

Further, the following can also be the characteristic of the foresaid human computer interaction device:

the said key input device is a soft device displayed on the said human computer interaction device; on the surface of the key region lies a key-shaped film, which is completely-transparent or between completely-transparent and completely-opacity, on which there are keyboard grooves with tactility; the said human computer interaction device may include, but is not limited to, one of or a combination of the following devices: electronic whiteboards, whiteboards, projection keyboard devices, touch screens, touch pads, the other touch devices, electrical input devices, electromagnetic induction devices, pressure devices, infrared devices, laser devices.

Further, the following can also be the characteristic of the foresaid human computer interaction device:

the said mouse simulation device includes one main simulation device; both of the said key input device and the said main simulation device are hard devices; the part of the said main simulation device in the key region of the said key input device consists of one or more small blocks of main simulation devices which agree with the keys of the said key input device in shape and size and are partitioned as per the normal boundary of a key position; further, in each small block of the main simulation device, there is a flexible mechanism which can be stretched and retracted or moved vertically; wherein the said main simulation device may include, but is not limited to, the following types of input devices or input and output devices or their combination: electronic whiteboards, whiteboards, projection keyboard devices, touch screens, touch pads, other touch devices, electrical input devices, electromagnetic induction devices, pressure devices, infrared devices, laser devices, and mechanical devices.

Further, the following can also be the characteristic of the foresaid human computer interaction device:

the said mouse simulation device includes a main simulation device which is partitioned into multiple regions in a formal, hidden, invisible or visible, implicit, explicit or displayed way, and the mouse function realized in each region may be different, and each of the said regions and their functions are fixed, variable or configurable; the said main simulation device may include, but is not limited to, the following types of devices or their combination: electronic whiteboards, whiteboards, projection keyboard devices, touch screens, touch pads, other touch devices, electrical input devices, electromagnetic induction devices, pressure devices, infrared devices, laser devices, and mechanical devices.

The invention provides a kind of electronic device, which includes the said various human computer interaction devices.

Further, the following can also be the characteristic of the foresaid electronic device:

the said human computer interaction device is an keyboard-type integrated keyboard and mouse simulation device of mobile phones, other hand-held devices or laptop computers, or a keyboard-type keyboard of desktop computers and a mouse simulation device set on the keyboard; or, the said human computer interaction device is a mouse simulation device which is set on the keyboard of the said electronic devices in a formal, hidden, invisible or visible, implicit, explicit or displayed way; or, the said human computer interaction device is a soft device which is set on the input and output device of the said electronic devices in a formal, hidden, invisible or visible, implicit, explicit or displayed way; the said input and output device may include, but is not limited to, the following types of input and output devices or their combination: electronic whiteboards, whiteboards, projection keyboard devices, touch screens, touch pads, other touch devices, electrical input devices, electromagnetic induction devices, pressure devices, infrared devices, and laser devices.

Further, the following can also be the characteristic of the foresaid electronic device:

the said human computer interaction device is a soft device displayed on the input and output device included in the said electronic devices; by means of the control by hardware or software, the said input and output device can determine the content or device to be displayed in a certain region, including realizing the switchover among multiple display devices or displayed contents; the said input and output device may include, but is not limited to, the following types of input and output devices or their combination: electronic whiteboards, whiteboards, projection keyboard devices, touch screens, touch pads, other touch devices, electrical input devices, electromagnetic induction devices, pressure devices, infrared devices, and laser devices.

Further, the following can also be the characteristic of the foresaid electronic device:

the said key input device is a soft device displayed or set on the said input and output device; the said mouse simulation device includes the touch pad or the other input and output device displayed or set on the said input and output device, the soft touch pad or other input and output devices displayed or set in the overlapping region when the mouse function is turned on, and the soft key input device displayed in the overlapping region when the mouse function is turned off; or

the said key input device and touch pad or other input and output devices are simultaneously displayed on an input and output device, wherein the display region of one device is completely transparent or is between completely-transparent and completely-opaque;

the said input and output device includes, but not limited to, the following types of devices or their combination: electronic whiteboards, whiteboards, projection keyboard devices, touch screens, touch pads, other touch devices, electrical input devices, electromagnetic induction devices, pressure devices, infrared devices, and the laser devices.

The invention provides a kind of human computer interaction method, which uses the said human computer interaction devices.

during the process of inputting through a key input device, when needing to use the mouse function, one can turn on part of or the whole of the mouse function, and can choose to operate the mouse simulation device of which at least partial operating region is located within a key region or within the other input device, and in such a mode, when needing to switch to a key input mode or the other mode, one can choose turning off the said mouse function; wherein, the said key input device and/or the mouse simulation device includes, but not limited to, the following types of input or input and output devices or their combination, or the soft device realized on an input/output device: electronic whiteboards, whiteboards, projection keyboard devices, touch screens, touch pads, other touch devices, electrical input devices, electromagnetic induction devices, pressure devices, infrared devices, laser devices, and mechanical devices.

Further, the said human computer interaction method still has the following characteristics:

Method A, when the mouse simulation device has a main simulation device, the mouse function can be realized separately through the operations on the said main simulation device;

Method B, when the mouse simulation device has a main simulation device, the mouse function can be realized through the operations on the said main simulation device and operating keys, and wherein the operating keys are used to realize part of or the whole of the button function of mouse;

Method C, when the mouse simulation device has a main simulation device and one or more auxiliary component(s) added and set on the keyboard, the mouse function can be realized through the operations on the said main simulation device and the auxiliary component(s);

Method D, when the mouse simulation device has multiple auxiliary components added and set on a keyboard, the mouse function can be realized through the operation(s) on the said auxiliary components.

Method E, when the mouse simulation device has multiple auxiliary components added and set on a keyboard, the mouse function can be realized through the operation(s) on the said auxiliary components and by means of an existing key or keys;

Method F, when the mouse simulation device has a main simulation device and one or more auxiliary components added and set on a keyboard, the mouse function can be realized through the operations on the said main simulation device as well as the auxiliary component(s) and an existing key or keys;

the said mouse function includes but is not limited to one or more of the following functions: executing, selecting, dragging, displaying menu, moving cursor, scrolling display screen, and multi-dimensional simultaneous moving display;

the said main simulation device includes but is not limited to the following types of input devices or input and output devices or their combination: electronic whiteboards, whiteboards, projection keyboard devices, touch screens, touch pads and other touch input devices, electrical input devices, electromagnetic induction devices, pressure devices, infrared devices, laser devices, and mechanical devices.

Further, the said human computer interaction method still has the following characteristics:

the said mouse simulation device or the main simulation device thereof is partitioned into multiple regions in an implicit, explicit or displayed way, including the regions used for realizing the function of cursor movement, and at least one region used for realizing at least one of the following functions: executing, choosing, dragging, displaying menu, scrolling screen, and multi-dimensional simultaneous moving display; and each of the said regions and their functions are fixed, variable or configurable.

Further, the said human computer interaction method still has the following characteristics:

the said mouse function is realized by one main simulation device arranged on the left or right side of the key region of the said key input device and certain keys arranged on the other side of the keyboard, and the said certain keys are one or more keys to which a finger or fingers will return after pressing a key or keys according to the standard fingering, and they are used to realize mouse's button function; or, the said mouse function is realized by a main simulation device, which is partially or completely arranged within the key region of the said key input device, and certain keys arranged outside the said main simulation device; among the said certain keys, the keys operated by left/right hand according to the standard fingering are used for realizing the function of mouse's left/right button, and the keys operated by right/left hand according to the standard fingering are used for realizing the function of mouse's right/left button;

Further, the said human computer interaction method still has the following characteristics:

the said auxiliary components at least include: one auxiliary component used for realizing the function of cursor movement and one auxiliary component used for realizing mouse's button function;

the said auxiliary components used for realizing mouse's movement function adopt one of or a combination of the following forms: at least one track point, at least one input device for controlling object's movement, at least one scroll ball for controlling object's movement, and at least one scroll wheel for controlling object's movement;

the said auxiliary components used for realizing mouse's button function adopt one of or a combination of the following forms: at least one button for confirming operations, at least one track point, at least one scroll ball, at least one input device for controlling object's movement, at least one scroll wheel and at least one operating key which can work under a mouse function mode.

Further, the said human computer interaction method still has the following characteristics: the said operations of turning on and turning off the mouse function are realized through one or more of the following methods:

turning on or turning off the mouse function by pressing or tapping the button(s) which is independently set on the keyboard for confirming operations;

turning on or turning off the mouse function by pressing or in sequence tapping the key combination(s) on the keyboard;

turning on or turning off the mouse function by touching the track point;

turning on or turning off the mouse function by turning one time the scroll ball;

turning on or turning off the mouse function by turning one time the scroll wheel;

turning off the mouse function when any input operation is received from the keyboard outside the operating region of the mouse simulation device;

turning off the mouse function when no operation is received from the mouse simulation device or the main simulation device thereof within the set time;

turning on or turning off the mouse function through finger's moving modes set on the mouse simulation device or the main simulation device thereof;

the said main simulation device may include, but is not limited to, the following types of input devices or input and output devices or their combination: electronic whiteboards, whiteboards, projection keyboard devices, touch screens, touch pads, other touch devices, electrical input devices, electromagnetic induction devices, pressure devices, infrared devices, laser devices, and mechanical devices.

Further, the said human computer interaction method still has the following characteristics:

when through the said moving modes that a finger or fingers set on the mouse simulation device or on the main simulation device thereof turn on or turn off a touch pad or the other device, the said moving modes include at least one of the followings:

the moving distance of finger(s) reaches or exceeds a set value;

the moving speed of finger(s) reaches or exceeds a set value;

the reciprocating frequency of finger's/fingers' movement reaches or exceeds a set value;

the pressure imposed by finger(s) on at least one key reaches or exceeds a set value;

a finger(s) moves or slides from the surface of one key to the surface of another key;

the moving track of finger(s) accords with a set shape;

a finger(s) clicks or double clicks the given point within a region, a certain region or the vertex of a certain region.

Further, the said human computer interaction method still has the following characteristics: the said main simulation device is to realize the mouse function as per the following methods:

after the said main simulation device is turned on, if there has been no slide or no click before, then the first click shall be regarded as clicking mouse's left button; and the first slide shall be regarded as controlling cursor's movement;

as clicking, if the most recent operation is a click or a slide, clicking the left side of the point of the last click or the final point of the last slide will be regarded as clicking mouse's left button and the function of clicking will be further maintained; clicking the right side of the point of the last click or the final point of the last slide will be regarded as clicking mouse's right button;

as clicking, if the most recent operation is a click or a slide, and a slide or a glide is started in the circle of which the center is at the point of the last click or the final point of the last glide and the radius is M, the slides or glides following it will be regarded as dragging until performing a new click or leaving the said main simulation device;

as gliding, if the most recent operation is a glide, gliding inside the region less than N away from the glide line and outside the circle of which the center is at the final point of the glide and the radium is M will be regarded as operating mouse's middle button;

the said M and N refers to a set distance.

Further, the said human computer interaction method still has the following characteristics:

the said key input device is a soft device, and it can move with a cursor's movement or a finger's or fingers' movement; when the cursor or finger(s) moves from the present position towards a key or keys to be operated, the whole key input device or the part thereof that the finger(s) move(s) towards will move towards the finger(s) synchronously or asynchronously.

Further, the said human computer interaction method still has the following characteristics:

the said mouse simulation device includes a main simulation device, and the region of the said main simulation device maps the whole or part of the screen; when a click is made on a certain point of the said main simulation device, the cursor will move to a point which is on the said screen and has mapping relation with the said point; meanwhile, when one unit is moved on the said main simulation device, the cursor will also move one unit on the said screen, or move multiple units as per the proportion in size between the said main simulation device and the said screen; the said main simulation device may include, but is not limited to, the following types of input devices or input and output devices or their combination: electronic whiteboards, whiteboards, projection keyboard devices, touch screens, touch pads, other touch input devices, electrical input devices, electromagnetic induction devices, pressure devices, infrared devices, laser devices, and mechanical devices.

Further, the said human computer interaction method still has the following characteristics:

when operating the said mouse simulation device, one can use a soft or hard nail, an artificial nail, a ring, a finger cap, a fingertip sheath, a finger article, a hand article or the other article as well as part of one of them and/or a combination of part of one of them to realize the positioning of the cursor or the displayed position.

Further, the said human computer interaction method still has the following characteristics:

as for the said articles used for the realization of positioning the cursor and the displayed position, their materials are: soft or hard metal, plastic, wooden products, biological products or the other soft or hard products.

Further, the said human computer interaction method still has the following characteristics:

as for the said articles used for the realization of positioning the cursor and the displayed position, their shape may be random, something having a cusp, sphere or oval sphere, or a polyhedron with 6, 8, 12 or 24 faces, or other curved surface, and part of one of them or a combination of part of one of them.

Further, the said human computer interaction method still has the following characteristics:

by moving the human body's certain points or parts felt or touched by the human body, the said mouse simulation device realizes the positioning and/or moving of the cursor or at least one of the followings relating to the cursor's formal, hidden, invisible or visible position, displacement or movement, or relating to the cursor's relative position: the formal, hidden, invisible or visible commands, command configurations, display modes, graphic representations, figures, images, command menu, buttons, keys or the commands or graphic representations which can be operated by clicks, the figures similar to the input and/or output devices, the human body's certain point or part which is felt or touched by the human body and which includes the touched centre point or the centre part of a finger or fingers; or an input operation is judged by the force, coverage or graphics of pressure.

Further, the said human computer interaction method still has the following characteristics:

when the said key input device and/or mouse simulation device is operated, shake, vibration, tingling, heat, twinkling and/or other feelings can be adopted to realize the hand-touch feeling and tactility.

From the present invention, we can see that a touch pad or the other mouse simulation device is arranged in the operating key region of the keyboard. When a keyboard input is required, operations can be performed by turning on the mouse simulation device. It is unnecessary to move the forearm frequently, so high efficiency, smaller volume and portability can be achieved. Meanwhile, applying the human computer interaction device in electric devices and integrating it with computers may enable computers to have more convenient and rapid human computer interaction, larger display space or better use of display space, and make computers, mobile phones, PDAs, PIMs, home appliances and so on more convenient, powerful and faster in function, and more convenient to be portable and using. Laptops and desktop computers and the other input devices which are more suitable for two hands are more suitable for use.

### BRIEF DESCRIPTION OF THE DRAWINGS

FIG. 1 is the schematic diagram of a human computer interaction device described in the Embodiment 1 of the present invention;

FIG. 2 is the schematic diagram of a human computer interaction device described in the Embodiment 2 of the present invention;

FIG. 3 is the schematic diagram of a human computer interaction device described in the Embodiment 3 of the present invention;

FIG. 4 is the schematic diagram of a human computer interaction device described in the Embodiment 4 of the present invention;

FIG. 5 is the schematic diagram of a human computer interaction device described in the Embodiment 5 of the present invention;

FIG. 6 is the schematic diagram of a human computer interaction device described in the Embodiment 6 of the present invention;

FIG. 7 is the schematic diagram of a human computer interaction device described in the Embodiment 7 of the present invention;

FIG. 8 is the schematic diagram of a human computer interaction device described in the Embodiment 8 of the present invention;

FIG. 9 is the schematic diagram illustrating the layout of a human computer interaction device on the touch screen as described in the Embodiment 9 of the present invention;

FIG. 10 is the schematic diagram of FIG. 9 without displaying the human computer interaction devices;

FIG. 11 is the schematic diagram illustrating the layout of a human computer interaction device on the touch screen as described in the Embodiment 10 of this invention, with additional soft keyboard protective film on the human computer interaction device as described in FIG. 9;

FIG. 12 is the schematic diagram illustrating the cross-section of the touch screen as described in FIG. 11;

FIG. 13 is the schematic diagram of the mouse pattern displayed on the touch pad surface as described in the Embodiment 9 of the present invention;

FIG. 14 is the schematic diagram of regional division displayed on the touch pad surface as described in the Embodiment 9 of the present invention;

FIG. 15 is the schematic diagram of regional division displayed on the touch pad surface as described in another Embodiment 9 of the present invention;

FIG. 16 is the schematic diagram of part of keyboard displayed on the screen of mobile phone.

FIG. 17 is the schematic diagram illustrating the position of the part of keyboard illustrated in FIG. 16 on the whole keyboard;

FIG. 18A and FIG. 18B are the schematic diagrams illustrating the two indication modes of two-dimensional simultaneous-movable function of the present invention.

### DETAILED DESCRIPTION OF THE PREFERRED EMBODIMENTS OF THE PRESENT INVENTION

In order to easily realize keyboard input and mouse function without moving the forearm, the human computer interaction device of the present invention realizes at least partial overlapping between the operating regions of the key input device and the mouse simulation device, thus enabling all normal people (non-disabled and non-mentally-handicapped, etc.) to operate the two devices without moving their arms.

In the present invention, the key input device can be a hard keyboard, a soft keyboard, or any device used for realizing input through keyboard operation, for example: a control panel. The “KEY” includes at least one or more of the followings: the formal, hidden, invisible, or visible keys, buttons, icons, menu items, commands, command configurations, display modes, knobs or the commands or graphic representations which can be operated by clicks, the figures similar to the input and/or output devices on the keyboard or on the control panel; the formal, hidden, invisible or visible, implicit, explicit or displayed keys, buttons, icons, menu items, commands, command configurations, display modes, knobs or the commands or graphic representations which can be operated by clicks, the figures similar to the input and/or output devices realized or displayed by means of software on the keyboard or on the control panel;

Mouse simulation devices (also called mouse analog devices) refer to various kinds of devices used for realizing the mouse function, except the mouse, such as touch screens, touch pads, track points, buttons, and the keys and wheels used for realizing the mouse function or a combination thereof, and so on. The said “mouse function” refers to various functions that can be realized by a mouse, such as executing (commands, icons), selecting (commands, icons), dragging (commands, icons), displaying the menu, scrolling the display screen, moving the cursor and so on. If a mouse is used, all these functions are usually realized by moving the mouse and operating the mouse's left, middle and right buttons. Particularly, the mouse function of the present invention (also directly called the mouse function) also includes those functions which are not applied in the existing mice but can be realized by a mouse, such as the function of multi-dimensional and simultaneous moving display published in the “Simultaneous multi-dimensional, accelerating and space-saving system display method used in IT field” (application number of Chinese invention patent: 200610046372.3) and the “Multi-dimensional information display and output control method and device and input device” (international application number: PCT/CN2007/001333).

The above said key input devices and mouse simulation devices can be hard devices or soft devices, and can be realized by using various kinds of input devices or input and output devices, such as electronic whiteboards, whiteboards, projection keyboard devices, touch screens, touch pads and other touch-input devices, electrical input devices, electromagnetic induction devices, pressure devices, infrared devices, laser devices, and mechanical devices. Some of these input devices can also be operated even when the fingers keep a certain distance from the input device. The following embodiments give a detailed description on some types of them.

The following gives a detailed description of the exemplary embodiments of the present invention with reference to the accompanying drawings.

### Embodiment 1

In this embodiment, the key input device of the human computer interaction device is a hard keyboard 1, and the mouse simulation device is composed of a hard touch pad 20, the structure of which is illustrated in FIG. 1. The hard touch pad 20 comprises the partial or whole surface of at least one operating key. As shown in FIG. 1, the hard touch pad 20 comprises part of the surfaces of the operating keys U, I, H, K, N and M and the whole surface of the operating key J, thus occupying an independent region within the operating key region of the hard keyboard 1. This region comprises the partial or whole surface of one or more operating keys, and even the whole operating key region of the hard keyboard is set as a hard touch pad. The hard touch pad 20 can be divided into several small blocks of hard touch pads, for example: division in light of the boundary of normal keyboard. Each small block of hard touch pad is equivalent to a hard touch pad of the prior arts in structure and working principle, and the combination of these small blocks of hard touch pads can achieve a complete hard touch pad. The small block of hard touch pad could also be a small display block or a small touch screen displayed in a key block shape (each display block is a small display screen or a small touch screen), and this small touch pad or small touch screen is provided with a flexible body that can be stretched and retracted or moved vertically, and it can be pressed down with better hand feeling.

The mouse function can be divided into two categories: one is movement function, which is used to move the cursor to a target position; the other one is button function (the middle wheel is regarded as the middle button), which is used for a variety of operations, such as confirmation, selection, execution (double click), dragging, pop-up menu, scrolling screen and so on. The existing hard touch pad can achieve the movement function and some of the button operations, such as single clicks, double clicks, dragging and other operations of the left button. Some of the button function can be realized through the buttons located below the hard touch pad. In this embodiment, through the operations on the hard touch pad, the whole mouse function can be realized without moving arms.

As there is an overlapping part between the keyboard and the hard touch pad, it is necessary to switch the working mode of this part, that is to say, during the process of keyboard input, the hard touch pad provided within the operating key region of the keyboard shall be turned on so as to perform operations on the hard touch pad. Of course, after a set of operations on the hard touch pad are completed, the hard touch pad could still be turned off.

In order to facilitate the operation, it is required to arrange a control switch on the keyboard to turn on or turn off the mouse function, namely, the function of the hard touch pad. In this embodiment, the control switch's function can be realized via at least one set of key combination, and any key combination (such as Ctrl+L) can be set, and the hard touch pad can be turned on or turned off by pressing this key combination. Through the customized operation mode on the hard touch pad, the control switch's function can also be realized irregularly. The said customized operation mode can be one or more of the followings: A, the movement distance of finger(s) within the hard touch pad reaches or exceeds the set value; B, the movement rate of finger(s) within the hard touch pad reaches or exceeds the set value; for instance, the length of “√” or “x” within 0.5 seconds exceeds 5 cm; C, the movement trajectory of finger(s) within the hard touch pad conforms to the set shape, such as, “V” “√” “x” “X”; D, click or double-click the fixed point(s), a region, the vertex of a region (such as key frame).

In this embodiment, operations on the hard touch pad are expanded, and the whole mouse function can be realized through the following method:

After the hard touch pad is started up, if there is neither a slide nor a click previously, the first click shall be regarded as clicking mouse's left button and the first slide shall be regarded as controlling the cursor's movement. as clicking, if the most recent operation is a click or a slide (also called glide), then clicking the left side of the point of the last click or the final point of the last slide shall be regarded as clicking mouse's left button and the function of click shall be further maintained, or shall be regarded as other preset functions; clicking the right side of the point of the last click or the final point of the last slide shall be regarded as clicking mouse's right button; if a slide or a glide is started in the circle of which the center is at the point of the last click or the final point of the last slide and the radius is 8 mm (or the other setting values M), the slides or glides following it shall be regarded as dragging until a new click begins; when a new glide starts, if the most recent operation is a glide, gliding inside the region less than 8 mm away from the glide line (or other setting values N) and outside the circle of which the center is at the final point of the glide and the radius is 8 mm (or other setting values M) will be regarded as operating mouse's middle button (for example: the function of scrolling screen);

In addition, for the soft keyboard realized on the touch screen or the touch pad, point-touching and tapping respectively represents the input of appropriate symbols, characters, images, graphics, and executing certain command or the function stood for by a certain key, and so on, and the slide is used as the mouse or multi-dimensional simultaneous moving function; when a slide exceeds 5 mm, the mouse simulation device of the touch screen will be started up, referring to 20 in FIG. 1, and when tapping occurs, such inputting characters through point-touching, the touch screen will be turned off and keyboard operation works.

In the following text, the method to individually realize the mouse function via a hard touch pad is called method A. And the mouse function can also be realized by replacing the hard touch pad with a touch screen, a projection keyboard, an electronic whiteboard and other input devices. As it is the same in the following embodiments, repetitious description will not be given here.

### Embodiment 2

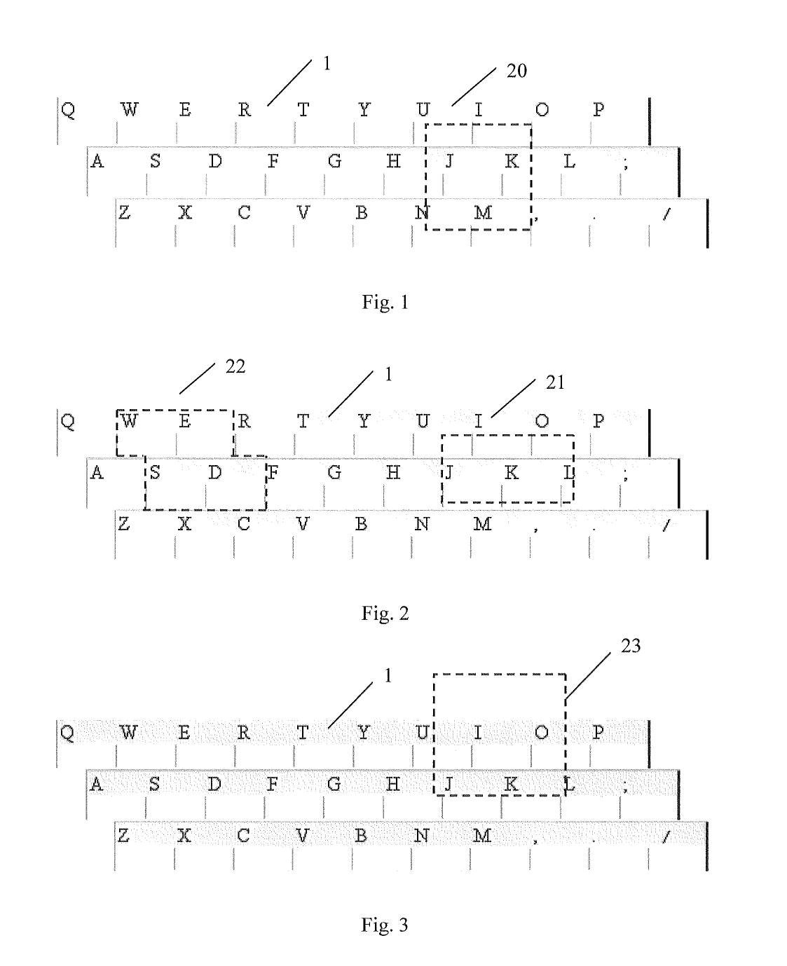

In this embodiment, the key input device of this human computer interaction device is a hard keyboard 1, and the mouse simulation device comprises a first hard touch pad 21 and a second hard touch pad 22, whose structures are illustrated in FIG. 2. The first hard touch pad 21 comprises part of the surface of the operating keys U, I, O, J, K and L; while the second touch pad 22 is composed of the whole surface of the operating keys W, E, S and D. In this embodiment, the hard touch pad occupies two independent regions within the operating key region of hard keyboard. The first and the second hard touch pads 21 and 22 are in two different shapes, and of course, both of them can be of the same shape in actual application. In other embodiments, the hard touch pad can occupy more independent regions (more than 2).

In this embodiment, the customized operation mode of the key combination and the hard touch pad or other modes can be adopted to turn on and turn off the mouse function, namely, the functions of the hard touch pad. The two hard touch pads can be controlled simultaneously or individually, or be set as simultaneous or individual control. The specific operations to realize the mouse function on the hard touch pad can be the same as the method A as described in the Embodiment 1.

### Embodiment 3

In this embodiment, the key input device of this human computer interaction device is a hard keyboard 1, and the mouse simulation device comprises a hard touch pad 23 and the four operating keys of “A”, “S”, “D” and “F” on the hard keyboard. Please refer to FIG. 3 for their structures. The hard touch pad 23 comprises the partial or whole surface of at least one operating key and the surface of the vacant region between or outside the operating keys. In FIG. 3, the hard touch pad 23 comprises part of the surface of the operating keys U, O, H, J, K and L and the whole surface of the operating key I, as well as the surface of the vacant region among the operating keys above the operating keys U, I and O. In this embodiment, the hard touch pad 23 occupies an independent region which comprises part of the operating key region of the hard keyboard and part of the vacant regions. In other embodiments, the hard touch pad may occupy more independent regions, and its area could be bigger than that of the operating key region of the hard keyboard.

In this embodiment, the customized operation mode of the key combination and the hard touch pad or other modes can be adopted to turn on and turn off the mouse function, that is, to turn on and turn off the functions of the hard touch pad 23 and the aforesaid four keys. The method to realize the mouse function is similar to the method of the combination of hard touch pad and buttons currently adopted on the modern laptop computers, but the four keys “A”, “S”, “D” and “F” are adopted to replace the traditional buttons to realize mouse's button function. Among the four keys, the key “F” is used to realize the functions of the right button, the key “A” is used to realize the functions of the left button and the keys “S” or “D” can individually realize the functions of the middle button. When the mouse function is turned on, the functions of these keys are switched to mouse's button function. In another way, only three keys “A”, “S”, “D” or “S”, “D”, “F” are used to realize the functions of the left, middle and right buttons from left to right in sequence.

The reason for using the above said keys is that, according to the standard fingering, our left hand will return to these keys in each input interval, and in this way, after the keyboard is switched to the mouse function mode, the button function can be realized with two hands instead of moving fingers, hence the increased input efficiency. Apparently, when the hard touch pad is arranged on the left side of the keyboard, three or four of the keys “J”, “K”, “L” and “;” can be used to realize the functions of mouse's left, middle and right buttons.

This embodiment provides another method that after the hard touch pad is turned on, the whole keyboard is under the mouse button function mode, then the operation on any one key used by left hand according to the standard keyboard fingering shall be regarded as the operation on mouse's left button, and the operation on any one key used by right hand shall be regarded as the operation on mouse's right button. Of course, it could be defined through many other methods or more functions could be defined.

This embodiment provides another method that the three operating keys “N”, “M” and “,” located below the hard touch pad as shown in FIG. 3 are used as the left, middle and right buttons respectively. As there are many selections, they will not be marshaled here.

In the following, the method to realize the mouse function via a hard touch pad and operating keys is called method B. Of course, based on the structure of this embodiment, the method A can also be adopted to realize the mouse function.

On the basis of embodiments 1, 2 and 3, also provided in the operating key region of the hard keyboard are at least one track pint, at least one scroll ball used for controlling object's movement and at least one scroll wheel used for controlling object's movement and/or at least one button used for confirming operations. They constitute the following new embodiments.

### Embodiment 4

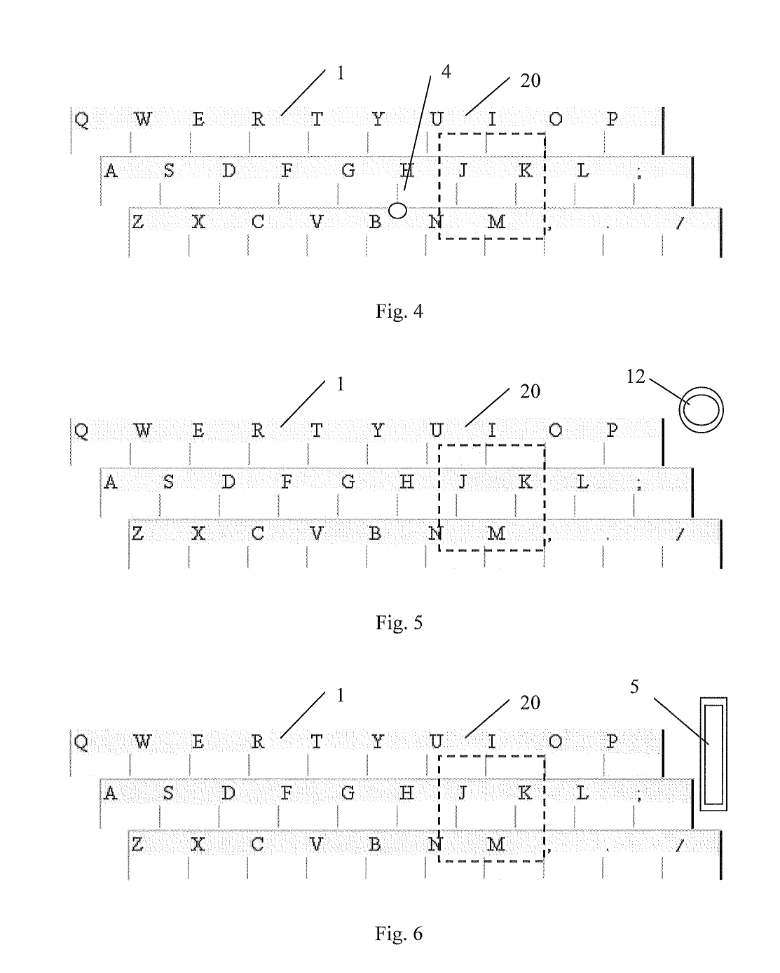

Referring to FIG. 4, based on the embodiment 1, a track point 4 is provided among the operating keys G, H and B in this embodiment. The keyboard of the human computer interaction device is a hard keyboard 1, and the mouse simulation device comprises a hard touch pad 20 and a track point 4. Of course, the track point 4 can also be provided among other operating keys. In this embodiment, although only one track point 4 is given, more track points can be arranged. Similarly, based on the structures described in the embodiment 2 and the embodiment 3, a track point can be added to obtain other methods.

In this embodiment, the track point 4 can be used to turn on and turn off the mouse function, for instance, to turn on or turn off the mouse function of the hard touch pad and track point by touching the track point. Of course, turning on and turning off the mouse function can also be realized through the customized operation mode of the key combination and the hard touch pad or other modes, and the track point can be only used to realize the mouse function.

In this embodiment, for the realization of the mouse function, a traditional hard touch pad is adopted to realize mouse's movement function and part of the mouse's button function. By tapping the above said track point 4, the function of clicking mouse's right button (or left button, or middle button) can be realized. When several track points are set up, the whole button function of mouse could be realized, for example, setting two track points 4 with one on the left and one on the right to realize the functions of mouse's left and right buttons respectively; or setting 3 buttons to realize the functions of mouse's left, middle and right buttons respectively. In addition, as with a hard touch pad, the track point has the movement function of a mouse, that is to say, operating either the track point or the hard touch pad can move the cursor. In the following, the method to realize the mouse function via a hard touch pad and the auxiliary components added and set on the keyboard is called method C.

Of course, based on the structure of this embodiment, method A and method B can also be adopted to realize the mouse function.

### Embodiment 5

As shown in FIG. 5, on the basis of the embodiment 1, the human computer interaction device in this embodiment arranges, on the right side of the operating key, a scroll ball 12 used for controlling object's movement; the keyboard of the human computer interaction device is a hard keyboard 1; and the mouse simulation device comprises a hard touch pad 20. Of course, the scroll ball 12 can also be arranged at other positions, and even the gap between some operating keys can be increased to place the scroll ball 12 therein. In this embodiment, although only one scroll ball 12 is given, more scroll balls can be arranged. Similarly, based on the structure described in the embodiment 2 and the embodiment 3, a scroll ball can be added to obtain other methods.

In this embodiment, the scroll ball 12 can turn on and turn off the mouse function, for instance, the hard touch pad will be turned on or turned off by touching the scroll ball. The mouse function can be realized through method A or method B.

However, based on the above structure, in other embodiments, the function of turning on and turning off the hard touch pad can be realized through the customized operation mode of the key combination and the hard touch pad, or other modes. And the scroll ball 12, as a part of the mouse simulation device, can be used to realize mouse's button function, for instance, it is used to realize the functions of mouse's middle button, such as scrolling screen or moving cursor, that is to say, the mouse function can be realized by adopting method C.

### Embodiment 6

As shown in FIG. 6, on the basis of the embodiment 1, the human computer interaction device in this embodiment arranges, on the right side of the operating key, a scroll wheel 5 used for controlling object's movement; the keyboard of the human computer interaction device is a hard keyboard 1; and the mouse simulation device comprises a hard touch pad 20. Of course, the scroll wheel 5 can also be arranged at other positions, and even the gap between some operating keys can be increased to place the scroll wheel 5 therein. In this embodiment, although only one scroll wheel 5 is given, more scroll wheels can be arranged. Similarly, based on the structure described in the embodiment 2 and the embodiment 3, wheel(s) can be added to obtain other methods.

In this embodiment, the scroll wheel 5 can turn on and turn off the mouse function, for instance, the hard touch pad will be turned on or turned off by touching the scroll wheel. The mouse function can be realized through method A or method B.

However, based on the above structure, in other embodiments, turning on and turning off the mouse function can be realized through the customized operation mode of the key combination and the hard touch pad, or other modes. The entire scroll wheel 5, as a part of the mouse simulation device, can be used to realize mouse's button function, for instance, it is used to realize the scrolling function of mouse's middle button, that is to say, the mouse function can be realized by adopting method C.

### Embodiment 7

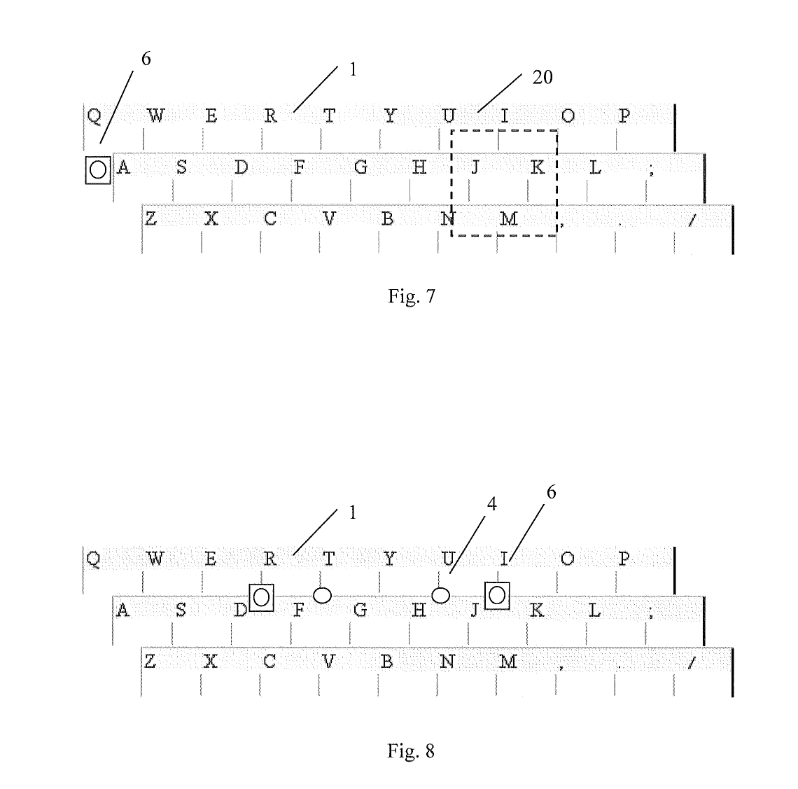

As shown in FIG. 7, on the basis of the embodiment 1, the human computer interaction device in this embodiment arranges, on the left side of the operating key, a button 6 used for confirming operations; the keyboard of the human computer interaction device is a hard keyboard 1; and the mouse simulation device comprises a hard touch pad 20 and a button 6. Of course, the button 6 can also be arranged at other positions, and even the layout of the keyboard can be changed so as to arrange the button 6 at a perfect position. In this embodiment, although only one button 6 is given, more buttons can be arranged. Similarly, based on the structure described in the embodiment 2 and the embodiment 3, button(s) can be added to obtain other methods.

In this embodiment, turning on and turning off the mouse function can be realized through the customized operation mode of the key combination and the hard touch pad, or other modes.

In this embodiment, the mouse function is realized through method C. As for the hard touch pad, a traditional hard touch pad is adopted to realize mouse's movement function and part of mouse's button function. By tapping the button 6, the function of clicking mouse's right button (or left button, or middle button) can be realized. When several buttons are set up, the whole button function of mouse could be realized, for example, setting two buttons, one on the left and one on the right, to realize the functions of mouse's left and right buttons respectively; or setting 3 buttons to realize the functions of mouse's left, middle and right buttons respectively.

However, based on the above structure, in other embodiments, the button 6 can be used to turn on and turn off the mouse function, for instance, the hard touch pad and the functions can be turned on or turned off by pressing the button 6. And the mouse function can be realized through method A or method B.

### Embodiment 8

In this embodiment, the key input device of the human computer interaction device is a hard keyboard 1, and the mouse simulation device comprises two track points 4 and two buttons 6. As shown in FIG. 8, on an ordinary standard keyboard, a track point 4 is arranged at the position among the operating keys R, T and F and also at the position among the operating keys Y, U and H, and a button 6 is arranged at the position among the operating keys E, R and D and also at the position among the operating keys U, I and J. Of course, the positions where the above track points and buttons are arranged can be changed, for instance, the positions among the operating keys D, F and C, among J, N and M, among F, G and V, among H, J and N and among T, Y and G, and so on are optional. The number of the additional track points 4 and buttons 6 can be one or more (three and more).

In this embodiment, turning on and turning off the mouse function can be realized through the customized operation mode of the key combination and the hard touch pad, or other modes. And the mouse function can be realized through the following methods: the two track points 4 arranged among the operating keys R, T and F and among the operating keys Y, U and H are respectively used to control cursor's movement and realize the scrolling function of mouse's middle wheel (optional); the buttons 6 arranged among the operating keys E, R and D and among the operating keys U, I and J (on the left and right sides of the center line of the keyboard) can be used to realize the single-click function, double-click function and other functions of mouse's left and right buttons. In the following, the method to realize the mouse function totally through the auxiliary component(s) added and set within the operating region of the keyboard instead of using the hard touch pad is called method D.

However, based on the above-mentioned structure, in other embodiments, another button or track point can be added to control the “TURNING ON” and “TURNING OFF” of the mouse function, or to realize the function through the customized operations on the track point, such as tapping.

The aforesaid human computer interaction devices can be integrated with the electronic devices and the automatic mechanical devices, in which hard keyboard is adopted, such as mobile phones, computers and so on. That is to say, the present invention also provides an electronic device with hard keyboard, in which any one of the human computer interaction devices mentioned above can be adopted thereon. This human computer interaction device can be arranged on the host of the electronic devices, for instance, a hard touch pad or auxiliary components can be arranged on the partial or whole surface of the fixed operating keys of the current laptop computers, or on the surface of the vacant region between the operating keys. Or, the said hard touch pad or auxiliary components can be arranged on the keyboard of desktop computers. The mouse function of these devices should be very sensitive, and it would be better to set them to the most sensitive mode, like a touch pad.

The above embodiments take into account the circumstances that a hard keyboard is adopted as a key input device, and there may be many other transformations, which will not be set forth one by one. The embodiments, in which a soft keyboard is used as a keyboard, will be elaborated in details as follows.

### Embodiment 9

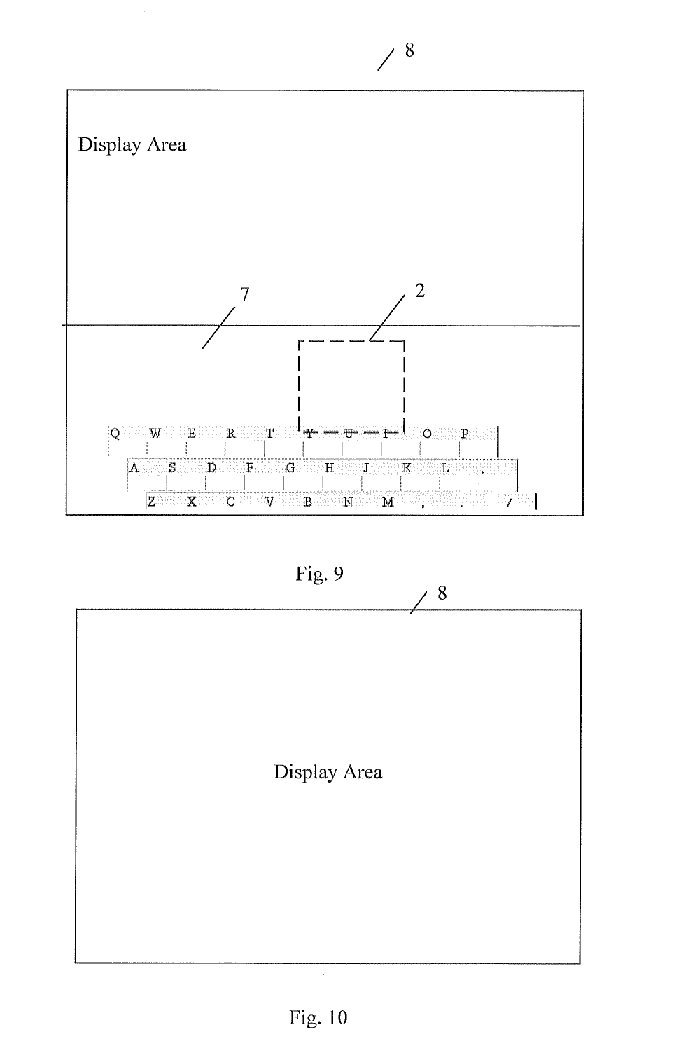

In this embodiment, the key input device is a soft keyboard 7, the mouse simulation device is a soft touch pad 2, and their structures are illustrated in FIG. 9. The soft keyboard 7 and the soft touch pad 2 are both displayed within the input region of the touch screen 8 (or other input devices that can display the content, such as electronic whiteboards, whiteboards, projection keyboard devices, touch screens, touch pads and other touch-input devices, electrical input devices, electromagnetic induction devices, pressure devices, infrared devices, laser devices, and mechanical devices. That is to say, both of the mouse simulation device and the key input device can be realized by means of the aforesaid input devices which can display the content. Other embodiments are the same as this.), and because both the soft keyboard 7 and the soft touch pad 2 are realized by using “software” mode, their manifestation features that the surface of at least one operating key of the soft touch pad 2 is partially or wholly overlapped with that of the soft keyboard 7. In this embodiment, the functions of the soft keyboard displayed on the touch screen are the same as that of the hard keyboard of IBM ThinkPad X61s laptop computers, and it can realize the command keys on the keyboard and key combinations, such as Ctrl+S, Ctrl+A, Ctrl+C, Ctrl+V, Ctrl+N, Win+E and Win+M and so on, and it also supports simultaneous input. For instance, if the interval between pressing two keys is within 100 ms (this value shall be settable), the two keys shall be regarded as the key combination of simultaneous input. The size of keys and keyboard is the same as that of the hard keyboard of IBM ThinkPad X61s laptop computers. There are IE, WORD, Outlook, Power key and other shortcut keys on the keyboard, and a slight change of their positions as well as the position of the outermost key(s) and the position of the indicator light will make the soft keyboard present rectangular. The original space key is reduced in size so as to leave its left part for the switching key.

In this embodiment, the surface of the soft touch pad 2 comprises the surface of part of the operating keys region and part of the vacant regions, and its structure and shape displayed are similar to FIG. 3 that adopts a hard keyboard. Apparently, the structure of any one of the human computer interaction devices, which adopt a hard keyboard, as described in the embodiments 1-9 and the structure of various transformations mentioned in these embodiments can be realized on the touch screen by means of software; and for the touch pads, buttons, track points and scroll wheels, their graphics and signs can be set at appropriate positions on the touch screen, and their functions can be realized by means of software, and they can be called soft touch pads, soft buttons, soft track points and soft scroll wheels. Thus the corresponding solutions for their realization on the touch screen are obtained. For example, for the embodiment 3, the keys “A”, “S”, “D” and “F” on the soft keyboard can be used to realize mouse's button function, or be slightly transformed, for instance, the position of mouse's left button should be within the rectangle which includes the position of the key F, and the position of mouse's middle button should be within a bigger rectangle of which the width is the key SD and which can be accommodated by the keyboard, and mouse's right button should be in the rectangle which includes the key A. The corresponding arrangement of other embodiments will not be depicted in detail one by one here.

In terms of display, the soft touch pad 2 and the soft keyboard 7 can be hidden when the content is displayed; the whole surface of the touch screen 8 is used as the display region, and only when an input is required by an operator, will the soft touch pad 2 and/or the soft keyboard 7 be displayed on the input region, and this process can be realized by the preset changeover switch or command as mentioned above, or the operator may activates the input region via the touch screen 8 to display the soft touch pad 2 and/or the soft keyboard 7.

For the display of the overlapping between the soft touch pad 2 and the soft keyboard 7, the method that the soft touch pad 2 covers the soft keyboard 7 can be adopted. The usual covering method is that the soft touch pad has an external frame and its internal part is transparent or nearly transparent, with its transparency not affecting the operator to use the soft keyboard 7. Of course, similar effect could also be achieved through covering the soft touch pad 2 with the soft keyboard 7 by means of software.

For the display of the overlapping between the soft touch pad 2 and the soft keyboard 7, another method is to display one device which is being in use, and when necessary, the operator can switch to another device display. Such switchover can be realized by a simple changeover switch or button, for instance, a soft return button used for returning to corresponding state can be arranged on both the soft touch pad 2 and the soft keyboard 7, and by this means such function can be realized. And it will be preferable to combine the method with the turning-on and turning-off of the mouse function, displaying the soft touch pad in the overlapping region when the mouse function is turned on, thus displaying the soft keyboard in the overlapping region when the mouse function is turned off. Such a method that different input devices can be simultaneously used or displayed in a same region or be used or displayed in different time in a same region is called regional overlapping herein. In the above embodiment, the method of using the same input device located in the same region to realize the key input function and mouse function (or other function combination) is called regional reuse herein, for instance, in the embodiment 1 the block touch pad is simultaneously used as keys and a touch pad.

The various implementation methods and their possible changes mentioned above also involve how to set a control switch to control the “turning on” and “turning off” of the (soft or hard) touch pad, for this purpose the methods mentioned in the embodiments 1-8 can be adopted, and the only difference is that for the hard keyboard the control switch is a hard control switch, and for the soft keyboard the control switch is a soft control switch. For instance, such soft control switch can be a soft track point, a soft scroll wheel, the soft buttons independently set to confirm operations, a key combination, or the customized operation mode of the touch pad, or the combination of the above methods.

In this embodiment, the following special method can be adopted to realize the mouse function on the touch pad, and such method belongs to method A, but it is different from the existing operations of the touch pad. In the following text, it is called method A_{E}:

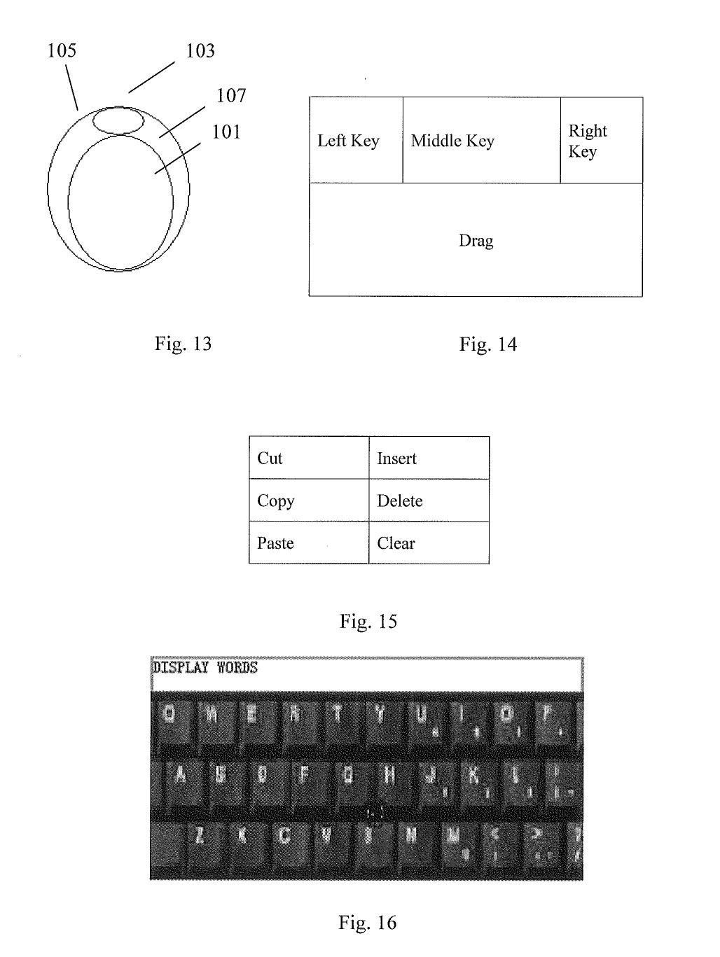

After the touch pad is turned on, a shape which is similar to or close to a mouse and is between completely-transparent and completely-opaque will be displayed on the surface of the touch pad. Please refer to the patterns illustrated in FIG. 13 and FIG. 14.

The pattern provided in FIG. 13 is a simulated mouse with an oval-shaped outline, in which a small oval 103 can be found in the center of the upper part, a big oval 101 is below the small oval, and the remaining part in the outline is divided into the left part 105 and the right part 107 by the two ovals. The oval 101 region is used to provide the function of the whole region of a regular touch pad, and starting a slide or a glide in the oval 101 can realize such mouse functions as cursor's movement, dragging, selection, and so on; the oval 103 region is used to provide the functions of mouse's middle button, and starting a slide or a glide in the upper oval 103 can realize the function of scrolling screen and other control and display functions. The remaining left part 105 is used to provide the functions of mouse's left button, and to click and press this region can realize the corresponding functions of clicking and pressing mouse's left button; the remaining right part 107 is used to provide the functions of mouse's right button, and to click this region can realize the corresponding functions of clicking mouse's right button.

The pattern provided in FIG. 14 is a rectangle, including the touch control region in the lower part and such soft buttons as the left button, middle button and right button in the upper part. Clicking and pressing the displayed soft buttons such as mouse's left, right and middle buttons on the touch pad or the touch screen shall respectively perform the corresponding operations of clicking a real mouse's left, right and middle buttons.

The patterns provided in FIG. 13 and FIG. 14 can be set to be explicit or hidden on the touch pad or on the touch screen, and clicking or sliding in different regions can perform corresponding operations. In addition, a cursor similar to the touch screen can be set to be explicit or hidden on the touch pad or on the touch screen so as to realize the similar function of displaying the cursor in an explicit way on the touch screen.

In the above design, the touch pad region can map the full-screen (that is to say, when a unit is moved on the touch pad, the movement of the cursor will be multiple units on the screen), or, when a unit is moved on the touch pad, the movement of the cursor may also be a unit on the screen.

In other embodiments in which mouse's movement function are realized in other ways, such as by means of a track point, the pattern of the touch pad can be designed to be a rectangle as shown in FIG. 15, which is divided into the left part and the right part. In the left part, starting from the upper part, there are at least 3 rectangular regions which are used to realize the operations of cut, copy and paste respectively; and in the right part, starting from the upper part, there are also at least 3 rectangular regions which are used to realize the operations of insertion, deletion, and clearance respectively. Of course, the above division is only an example, and there are many selections on the number, location and corresponding operation of the regions, and they will not be set forth here. Meanwhile, the touch pad can be configured to multiple regions according to different ways, and these regions can be explicit or implicit.

The touch pad or touch screen of the said mouse simulation device is used to realize most of the mouse function and can be called the main simulation device of mouse. The said main simulation device can adopt the following types of devices or their combination: electronic whiteboards, whiteboards, projection keyboard devices, touch screens, touch pads, other touch devices, and electrical input devices, electromagnetic induction devices, pressure devices, infrared devices and laser devices.

### Embodiment 10

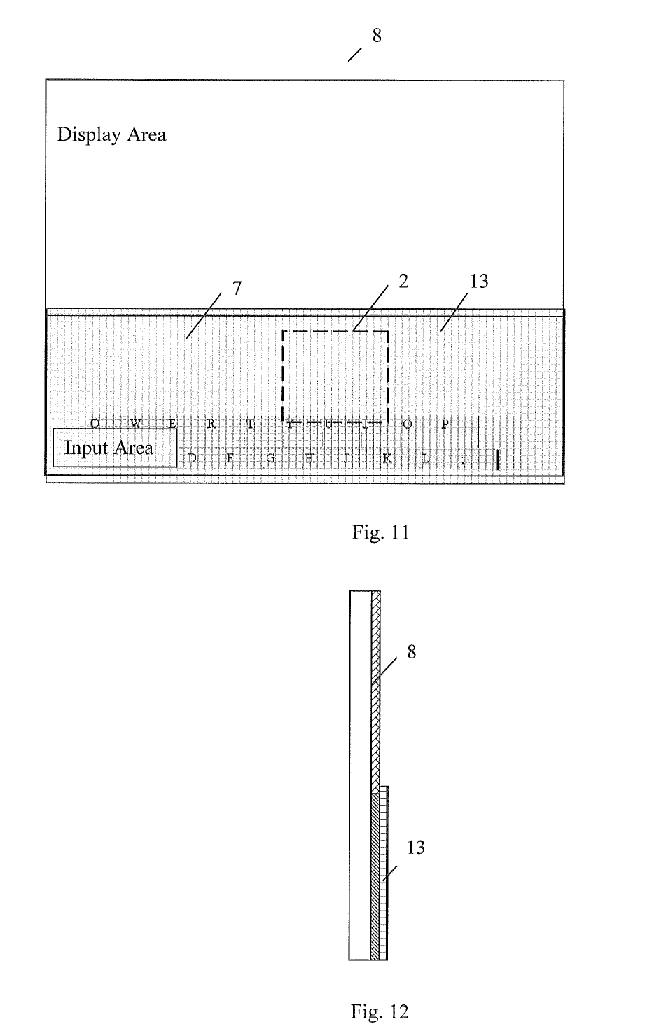

In this embodiment, the soft keyboard 7 is covered by a soft keyboard protective film 13, and other than this, there is no difference between the embodiment 10 and the embodiment 9, as shown in FIG. 11. And as shown in FIG. 12, the soft keyboard protective film 13 is provided on the surface of the touch screen 8 but within the region where the soft keyboard 7 is displayed, and usually it is slightly bigger than the region occupied by the soft keyboard 7. For the purpose of producing no distinction when a display begins, it will be better to provide a soft keyboard protective film 13, which is completely transparent or has better transparency, on the whole surface of the touch screen 8. Herein the transparent soft keyboard protective film 13 is used to improve the hand feeling upon inputting and further make the soft keyboard 7 feel like a real hard keyboard. In addition, grooves can be added between the keys on it, for instance, 0.5 mm deep and 0.5 mm wide grooves can be added, thus sufficiently creating a feeling of real and different keys.

In this embodiment, the mouse function can adopt any one of the above methods A˜D and A_{E}, and what is different for the methods A˜D is only that the keys, touch pad and auxiliary components operated are the soft devices displayed on the screen, but the concrete method keeps unchanged.

### Embodiment 11

In this embodiment, both the composition and operation mode of this human computer interaction device can be the same as that in the embodiment 9. However, there is a certain difference in the display mode of the touch screen.

In this embodiment, the key input device and the mouse simulation device of this human computer interaction device are not displayed at a fixed position on the touch screen, but nearby the cursor, such as the upside, downside, left and right of the cursor, or are completely or partially overlapped with the cursor, and different shapes, colors and transparency can be used to distinguish them from the background. For instance, IE, OFFICE, and other applications can be displayed, by selection, on the keyboard (don't let the keyboard cover up the document) or on the background, or be displayed in a staggered manner. The start bar can be displayed, by selection, closely next to the downside or upside of the keyboard.

The human computer interaction device can also be designed to allow keys to move according to a cursor's or a finger's or fingers' movement. For example, when a finger is going to move (or slide, etc.) from one position to a key or keys for operation, the entire key input device, such as the keyboard, or some section of it that the finger is moving towards on the keyboard will move in a direction opposite to the movement of the finger. So, on some occasions that only a part of the keys on the keyboard can be displayed due to the restriction of size of the screen, the keys to be operated can be moved into the screen and displayed. As shown in FIG. 16, it is a foldable mobile phone, the rectangle in the middle is a touch screen, and the mobile phone can be folded along the midline of the FIG. 16. In terms of the mobile phone with a standard keyboard, since the size of its screen is limited, only a part of the keyboard region can be displayed at a time, above mentioned method can be used to realize the input operation of all keys as inputting in the screen.

Even for the soft keyboard of which all keys can be displayed, such movement is also helpful and it enables operators to operate the distant keys without managing to stretch their fingers, and just moving a very short distance in the direction towards the wanted key(s) on the screen can make the key(s) automatically move to the vicinity of the fingers so that the key(s) can be easily operated and the operation accuracy can be improved accordingly. The moving speed of the keyboard can be greater than that of the fingers; of course, it can also be the same as or less than the speed of the fingers. During the movement, one or more target keys that the fingers are moving towards can be turned into bigger or appropriately transformed, while other keys adjacent to the target keys can be turned into smaller or go far away.

The movement relative to the cursor's movement is similar to this, and the only difference is that what should be identified is the movement of the cursor but not the fingers. The movement of the cursor can be achieved by using the mouse simulation device described in the present invention or by other means.

It should be noted that the aforesaid solution of key's or keys' moving relative to the movement of fingers or cursor can be adopted independently, that is to say, there is no need to adopt the solution of partially overlapping the key input device with the mouse simulation device. Even on some electronic devices without mouse function, this method can also be adopted to realize input without moving the forearm and overcome the screen size restriction and improve the accuracy of input.

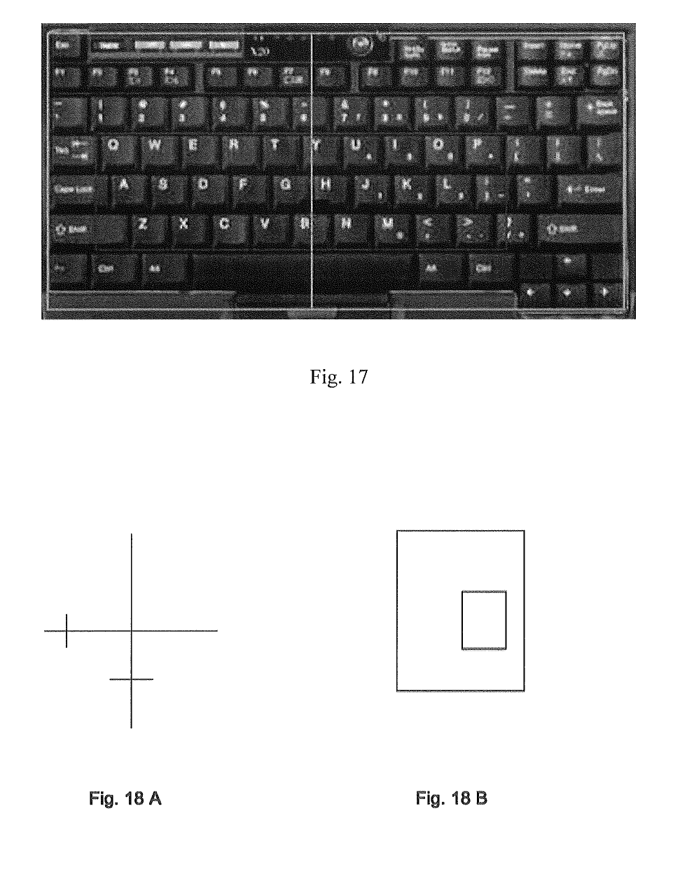

In this embodiment, the touch pad can also realize a synchronous movement in two/multi-dimensions, namely, the function of scrolling screen in two/multi-dimensional directions, FIG. 16, FIG. 17, FIGS. 18A and 18B being referred. What is shown in FIG. 16 is a part of a keyboard, and its position on the keyboard is shown in FIG. 17. And in FIGS. 18A and 18B, by moving the cross and the big rectangular or the small rectangular respectively, the specific position of the part of the keyboard shown in FIG. 16 on the whole keyboard is indicated. Such function can be set to mouse's middle button function, for instance, operations and display can be realized in the region which corresponds to the middle button operations and is in the display region of the touch pad shown in FIG. 13 and FIG. 14. In FIG. 18A, the short lines on the cross indicate the current changes in the abscissa and ordinate displayed in the whole graphics; on the contrary, when such short lines on the cross are moved, the change of the abscissa and ordinate in the whole graphics will be displayed currently, with “+” shape indication. In FIG. 18B, the small rectangular stands for the region being displayed, and the big rectangle stands for the displayed document and the displayed position change, and the small rectangular indicates its position relative to the big rectangle and its corresponding changes. It is required to move nimbly and follow instantly, and the multi-dimensional simultaneous moving display can be realized as long as there is a curve starting from the middle button (the curve can be terminated at any position).

In addition, the keys or symbols of the keyboard can be characterized by a variety of colors, for instance, the keys Q, W, E, R, T, Y, U, I, O and P adopt the first color like blue; the keys A, S, D, F, G, H, J, K and L adopt the second color like red; and the keys Z, X, C, V, B, N, M, . . . , / adopt the third color like green. In terms of display effect, when any key is pressed, color flicker\luminescence\conversion and so on will occur; and color flicker\luminescence\conversion will occur for game player soft keyboards\phone keyboards\computer keyboards and so on.

On the human computer interaction device described in this embodiment, a wide range of keyboards can be displayed, and shift+1 or a variety of other means can be used to achieve the switchover among multiple soft keyboards. For instance, Shift+S\D\F can be used to choose at least three kinds of commonly-used keyboards: (punctuation) symbol keyboards, phonetic keyboards, the other commonly-used keyboards for symbols input, the keyboards of mobile phones, game keyboards and so on. In addition, the size and shape of the display region of the above-mentioned human-computer interaction device can be adjusted. For instance, the keyboard can be minimized, dragged and turned off, and can get smaller and bigger in size. The size of the keyboard displayed on a 17″ and 14.1″ widescreen should be the same as the actual size too.

The aforesaid human computer interaction devices realized on the touch screen can be integrated with electronic devices, such as mobile phones and computers, as well as automatic mechanical devices, both of which have touch screen. That is to say, the present invention also provides a kind of touch-screen electronic devices, and any one of the aforesaid human computer interaction devices can be adopted thereon. This human computer interaction device can be displayed on the touch screen of the electronic devices, or whether its display on the touch screen of the electronic devices can be controlled by whether the input region, the display control switch of hardware or software is touched by someone or some object. The advantage of such method is to remove from the electronic devices the hard keyboard and the touch pad, which occupy much space, thus making way for the screen. More specifically, the keyboard, mouse, display and touch screen are re-used and integrated, and can be integrated with computers, which may enable computers to have more convenient and rapid human computer interaction, larger display space or better use of display space, as well as make computers, mobile phones, PDAs, PIMs, home appliances and so on more convenient and powerful in function, smaller in size, larger in display space or better in use of display space, and easier in carrying and use.

Because realizing mouse function inside a computer or on other logic operation devices is a very mature technology, the above embodiments mainly introduce the operation modes adopted and the operational objects with respect to the realization of the mouse function. Based on the above knowledge, any ordinary skilled technician of this field can easily perform the technical solutions in the present invention.

One of the human computer interaction methods described in the present invention is the method to turn on or turn off the mouse function. Besides the methods introduced in the above embodiments, there are also other methods, so a collective explanation on them will be made again in the following text, specifically including at least one of or a combination of the following methods:

1. To turn on or turn off the mouse function by pressing or tapping the operation confirmation button(s) independently arranged on the keyboard.

This method is easy to understand. As shown in FIG. 6, arrange one button on the keyboard, and press it to turn on or turn off the mouse function, then press it once again to turn off or turn on the mouse function. The keyboard can be a hard keyboard or a soft keyboard; of course, the corresponding button shall be a hard button or a soft button.

2. To turn on or turn off the mouse function by pressing or tapping the key combination on the keyboard in sequence.

This method is easy to understand. Key combinations are commonly used in computers, for example, Ctrl+Alt+Del is a warm boot key combination often used in computers. In the present invention, key combinations (as long as they would not make conflicts with the key combinations of the system) can be set at discretion, such as Ctrl+L, Alt+O, Shift+U . . . . In application, press the key combination to turn on or turn off the mouse function, then press the key combination once again to turn off or turn on the mouse function. The keyboard can be a hard keyboard or a soft keyboard, and if it is a soft keyboard, the method to turn on or turn off the mouse function is to press the key combination in sequence.

3. To turn on or turn off the mouse function by touching the track point

According to this method, the track point is set in the operating key region of the hard keyboard. Touch the track point to turn on or turn off the mouse function, and then touch the track point once again to turn off or turn on the mouse function.

4. To turn on or turn off the mouse function by turning the scroll ball

According to this method, a scroll ball is set in the operating key region of the hard keyboard. Turning the scroll ball will turn on or turn off the mouse function, and during this process, if the scroll ball is turned continually (Its delay time can be set, and if the delay time is exceeded, the turning will not be regarded as continuous turning.), the scroll ball function of a common mouse will be realized; and turning the scroll ball once again will turn off or turn on the mouse function.

5. To turn on or turn off the mouse function by turning the scroll wheel

According to this method, the scroll wheel is set in the operating key region of the hard keyboard. Turning the scroll wheel will turn on or turn off the mouse function, and during this process, if the scroll wheel is turned continually (Its delay time can be set, and if the delay time is exceeded, the turning will not be regarded as continuous turning.), the scroll wheel function of a common mouse will be realized; and turning the scroll wheel once again will turn off or turn on the mouse function.

6. To turn off the mouse function when input operations from the keyboard are received

During the input operation by means of the mouse simulation device, once the system receives input operations from the keyboard outside the operating region of the mouse simulation device, the mouse function should be turned off immediately to prevent from any misoperation resulting from pressing or tapping any keys located within the mouse function regions during the input process. This equals to regarding an operating key outside the operating region of the mouse simulation device as a control switch. Of course, at this time, it is not applicable to the situations that keys are applied to realize mouse's button function.

7. To turn off the mouse function when no operation from the mouse simulation device is received within the set time

During the input operation by means of the mouse simulation device, if the system receives no operation from the mouse simulation device within the set time, the mouse function should be turned off to prevent from any misoperation resulting from pressing or tapping any keys of the mouse simulation device during the stand-by time.

8. To turn on or turn off the mouse function through finger's moving modes preset on the touch pad

Functioning as an artificial operation, touching touch pad with fingers has diverse modes and complicated realization ways, and the main control ways are given below:

1) The moving distance of a finger within the touch pad region reaches or exceeds the set value

This method means that during the input operation on the keyboard, if one wants to turn on the mouse function, what he/she needs to do is to make a finger movement of larger displacement within the touch pad region, thus the mouse function will be turned on; and the range of this displacement or the distance of this movement should be bigger than the distance that the finger may slide over the keys in a natural way during the ordinary input operation on keyboard, so as to prevent from generating misopertion. Of course, the distance of the movement can be specifically set as required through the system.

2) The Moving Speed of a Finger within the Touch Pad Region Reaches or Exceeds the Set Value

This method means that during the input operation on the keyboard, if one wants to turn on the mouse function, what he/she needs to do is to move his/her finger quickly within the touch pad region, then the mouse function will be turned on; and the value of this moving speed should be higher (or lower) than the finger's natural moving speed over the keys during the ordinary input operation on the keyboard, so as to prevent from generating misoperation. Of course, this moving speed can be set through the system. Since this moving speed can be set different from the natural moving speed of the operations on the touch pad, during the input operation after the mouse function is turned on, if one wants to use the keyboard for input, what he/she needs to do is to make a rapid finger movement within the touch pad region, then the mouse function will be turned off.

3) The Reciprocating Frequency of a Finger's Movement within the Touch Pad Region Reaches or Exceeds the Set Value

This method means that during the input operation on the keyboard, if one wants to turn on the mouse function, what he/she needs to do is to make his/her finger repeat reciprocating movement several times within the touch pad region, then the mouse function will be turned on; the value of this reciprocating frequency should be larger than the frequency of the finger's natural reciprocating movement over the keys during the ordinary input operation on the keyboard, so as to prevent from generating misoperation. Of course, the reciprocating frequency can be set through the system. Since the reciprocating frequency can be set different from the frequency of the natural reciprocating movement occurred in the operations on the touch pad, during the input operation after the mouse function is turned on, if one wants to use the keyboard for input, what he/she needs to do is to make his/her finger repeat reciprocating movement several times within the touch pad region, then the mouse function will be turned off.

4) The Pressure Imposed by a Finger or Fingers on at Least One Key within the Touch Pad Region Reaches or Exceeds the Set Value

This method means that during the input operation on the keyboard, if one wants to turn on the mouse function, what he/she needs to do is to make his/her finger(s) impose the set pressure on at least one key within the touch pad region, then the mouse function will be turned on; and the value of the set pressure should be larger than the finger's or the fingers' natural pressure on the key(s) during the ordinary input operation on the keyboard, so as to prevent from generating misoperation. Of course, the set pressure can be set through the system. Since this set pressure can be set different from the natural pressure imposed in the operations on the touch pad, during the input operation after the mouse function is turned on, if one wants to use the keyboard for input, what he/she needs to do is to make his/her finger(s) impose the set pressure on at least one key within the touch pad region, then the mouse function will be turned off.

5) Finger's Movement from the Surface of One Key to the Surface of Another Key within the Touch Pad Region

This method means that during the input operation on the keyboard, if one wants to turn on the mouse function, what he/she needs to do is to move or slide his/her finger(s) from the surface of one key to the surface of another key within the touch pad region, then the mouse function will be turned on; since this method can be used in conjunction with the fifth method ‘To turn off the mouse function when input operations from the keyboard are received’, therefore, even any two keys located within the touch pad region are used continuously during the input operation on the keyboard, no misoperation will be generated.

6) The Moving Track of a Finger within the Touch Pad Region Accords with the Preset Shape

This method means that during the input operation on the keyboard, if one wants to turn on the mouse function, as long as his/her finger's movement within the touch pad region meets the track of the preset shape, the mouse function will be turned on; for example, the mouse function will be turned on when a “√”, “O”, or “̂” . . . is drawn. Of course, the track of this preset shape can be set through the system.

However, during the input operation after the mouse function is turned on, if one wants to use the keyboard for input, as long as his/her finger's movement within the touch pad region meets the track of the preset shape, the mouse function will be turned off; for example, the mouse function will be turned on when a “X” or “-” . . . is drawn.

### 7) Single Click or Double Click of the Given Point, a Certain Region or the Vertex of a Certain Region on the Touch Pad

For the human computer interaction devices presented in the present invention, as long as there are the hardware required for realizing the aforesaid control methods, such as a touch pad and auxiliary components, then any one of these control methods can be adopted to turn on or turn off the mouse function.

In all of the above embodiments, the following methods can also be provided to realize precise positioning and generate tactility:

For example, when the realization of precise positioning or movement is required on such input devices as touch pads or touch screens during the operation, one can use hardware such as a nail, an artificial finger-tip shell type nail, a soft or hard ring, a finger cap, a fingertip and so on to realize the precise positioning of the cursor and a displayed position. The materials of such kinds of hardware can be: soft or hard metal, plastic, wooden products, biological products and so on; their shape may be random, for example: something having a cusp (can be a small spherical point), or a sphere and oval sphere, or a polyhedron with 6, 8, 12 or 24 faces, or other curved surface, and part of them or the combinations of them, such as a rigid plastic fingertip ring with a steel ball tip.

In addition, the precise positioning and movement can be rapidly realized through the movement of the central points of the part of the human body, or the central parts of the human body contacted with such input devices as touch pads or touch screens. The precise positioning and movement can be rapidly realized through the movement, speed or acceleration of the central parts or central points of the touch coverage detected by the input devices such as the touch pad or the touch screen. When multiple keys are tapped, the key with biggest touch coverage shall be judged as the input key.

In order to also realize the tactility like operating on a real keyboard in the overlapping region between the key region and the touch pad region, a completely-transparent thin film with keyboard grooves and tactility and in the keyboard shape can be set on the said overlapping region. In addition, shake or vibration (such as the vibration like many mobiles make, but very slight and rather short, and its intensity is proportional to finger's pressure on the touch screen and the contact coverage between the finger and the touch screen) and twinkling are adopted to realize a real hand feeling and touching feeling.

In summary, what are described above are only the preferable embodiments of the present invention. In the content part of the present invention, there are many other transformation methods, which will not be given here one by one. The protection scope of the present invention is not limited to this, and any transformations or replacements which may be easily conceived of by the technicians who are familiar with the field of this technology within the technical scope disclosed in the present invention shall be included in the protection scope of the present invention. Therefore, the protection scope of the present invention shall be subject to the protection scope specified in the claims.

Moreover, the abovementioned operations on the touch pad can be replaced by an additional induction device, if so, touching will not be necessary, and corresponding operations can also be realized by means of the finger hanging in the air (in a certain height, such as <=15 mm or 10 cm).

For example, an input will be identified only when the operations on the touch pad, such as clicks, slides/glides and so on, exceed a certain pressure (such as the pressure of the finger resting on it), and only the identification of a certain force can confirm the input by the finger.

### INDUSTRIAL PRACTICABILITY

In the present invention, a touch pad is arranged in the operating key region of the keyboard. When a keyboard input is required, operations can be performed by turning on the said touch pad.

It is unnecessary to move the forearm frequently, so high efficiency and portability can be achieved. Meanwhile, applying the human computer interaction device in electric devices and integrating it with computers may enable computers to have more convenient and rapid human computer interaction, larger display space or better use of display space, as well as make computers, mobile phones, PDAs, PIMs, home appliances and so on more convenient, powerful and faster in function, smaller in size, larger in display space or better in use of display space, and easier in carrying and use.

1. A human computer interaction device, comprising a first input device and a second input device, which is characterized in that at least part of the operating regions of a certain function or all functions of the said second input device is located within the key operating region of the said first input device; or,
a human computer interaction device, comprising a second input device or a part thereof and a first input device or a part thereof, wherein within any region of any size at any position including the region or space of the said part of or the whole of the second input device and the said part of or the whole of the first input device, the said part of or the whole of the second input device and the said part of or the whole of the first input device use the same region or space, that is, overlapping or reuse of a part of or a whole of a region or a space; or,
a human computer interaction device, which is characterized in that it comprises a second input device or a part thereof and a first input device or a part thereof; and the said second input device or a part thereof and the said first input device or a part thereof use the same region or space within any region of any size at any position within a region or space of the said part of or the whole of the second input device and the said part of or the whole of the first input device; namely, a whole or partial overlapping or reuse of a region; and the said regional\spacial\dimentional overlapping or regional\spacial\dimentional reuse is the regional\spacial\dimentional overlapping or regional\spacial\dimentional reuse in the same time or in different time; or,
at least part of the operating regions of the said second input device is located within the key operating region of the said first input device other than the devices with special/only mouse function or limited function, wherein the devices with limited function mean that the function of the said device are limited or the number of the functions of the said device is limited; the first input device other than the devices with special/only mouse function or limited function may include, but is not limited to, hard devices or soft devices; or,
a human computer interaction device, which is characterized in that it comprises a second input device used for realizing a mouse function and a first input device, wherein, the region where the said second input device is located should be overlapped at least partially with the region where the first input device is located, and the region where the said first input device is located consists of the region where one or more keys are located, and doesn't include the regions between these input keys; or,
a human computer interaction device, which is characterized in that it comprises a touch pad, a touch screen or the other hard input device used for realizing a mouse function and a first input device, wherein, the said touch pad, touch screen or the other hard input device are the devices that realize input by means of touching, and moreover, the region where the said touch pad, touch screen or the other hard input device is located is overlapped at least partially with the region where the first input device is located, and the region where the said first input device is located consists of the region where one or more keys are located and the region between these input keys; or,
a human computer interaction device, which is characterized in that it comprises a second input device used for realizing a mouse function and a soft first input device, wherein, the region where the said second input device is located is overlapped at least partially with the region where the soft first input device is located; the region where the said soft first input device is located consists of the region where one or more input keys are located and the region between these input keys; or,
a human computer interaction device, which is characterized in that it comprises a second input device used for realizing a mouse function and a first soft input device; or,
all of the first input devices said above can be replaced with an input device, wherein the input device includes a key input device or key input devices.

2. The human computer interaction device according to claim 1, which is characterized in that:
the said regional\spacial\dimentional overlapping or regional\spacial\dimentional reuse means the regional\spacial\dimentional overlapping or regional\spacial\dimentional reuse in same time or in different time; or,
the said first input device is a key input device, namely, the device that input can be realized through key operations; the said ‘key’ includes one or more types as follows: the formal, hidden, invisible or visible keys, buttons, icons, menu items, commands, command configurations, display modes, knobs or the commands or graphic representations that can be operated by clicks, the figures similar to the input and/or output devices on the keyboard or the control panel; the formal, hidden, invisible or visible, implicit, explicit or displayed keys, buttons, icons, menu items, commands, command configurations, display modes, knobs or the commands or graphic representations that can be operated by clicks, the figures similar to the input and/or output devices realized or displayed on the keyboard or the control panel by means of software; or,
the said second input device is a mouse simulation device used for realizing a mouse function, and the said mouse function includes, but is not limited to, one or more functions as following: executing, selecting, dragging, displaying menu, moving cursor, scrolling display screen, and multi-dimensional simultaneous moving display;
the said key input device and/or the mouse simulation device include(s) the following types of input devices or input and output devices or their combination, or soft devices realized on input/output devices: electronic whiteboards, whiteboards, projection keyboard devices, touch screens, touch pads, other touch devices, electrical input devices, electromagnetic induction devices, pressure devices, infrared devices, laser devices, and mechanical devices.

3. The human computer interaction device according to claim 2, which is characterized in that:
the said mouse simulation device includes the partial or whole surface of at least one key or part of or the whole of a region between keys, and it can be located in an independent region within the key region of the said key input device, or partial said mouse simulation device is located within the key region, and the remaining part is located in the other region;
or, regional reuse of the overlapping part between the said mouse simulation device and the said key region can work under at least two modes—a key input mode and a mouse function mode;
or, there exists regional overlapping or regional reuse between at least part of the operating region of the said mouse simulation device and the key operating region of the said key input device, namely, the same region can be used for or realize the function of random more different devices.

4. The human computer interaction device according to claim 2, which is characterized in that:
the said mouse simulation device includes one or more auxiliary components within or outside the key operating region of the said key input device, and theses auxiliary components are used to realize the whole or part of the mouse function of the human computer interaction device; or, part of the liked mouse function that these auxiliary components are used for realizing, including the functions of ‘displaying menu’ or ‘multi-dimensional simultaneous moving display’.

5. The human computer interaction device according to claim 1, which is characterized in that:
on the said human computer interaction device, one or more control switches are also set to turn on or turn off the mouse function; the control switches will be soft or hard control switches, and the regions where the above said switches are located are as follows:
in or near the regions where the first input device or the second input device is located; or,
in the region where the first input device is located and which is overlapped at least partially with the region where the second input device is located; or,
in the region where the soft/hard keyboard-type keyboard of desktop computers, the keyboard-type keyboard of laptop computers, or the keyboard that is more than X cm long, is located, each of which is overlapped at least partially with the region where the second input device is located; wherein X is 8, 10, 12, 14, 16 or 18; or,
in the region Y cm away from the space key of the soft/hard keyboard-type keyboard of desktop computers, the keyboard-type keyboard of laptop computers, or the keyboard that is more than X cm long, each of which is overlapped at least partially with the region where the second input device is located; wherein Y is 1, 3, 5, 7 or 9.

6. The human computer interaction device according to claim 5, which is characterized in that:
the said control switch adopts one of or a combination of the following forms: at least one independently-set button, at least one track point, at least one scroll ball, at least one scroll wheel, at least one set of key combination, at least one operating key outside the mouse simulation device region, at least one operation mode customized on the said human computer interaction device.

7. The human computer interaction device according to claim 3, which is characterized in that:
the said mouse simulation device includes one or more main simulation devices, and one or more auxiliary components set in or near the key region of the said key input device; the said main simulation device and the said touch device together realize the whole or part of the mouse function of the said human computer interaction device, which at least include the auxiliary component(s) used for realizing the function of cursor movement and the auxiliary component(s) used for realizing mouse's button function;
the said main simulation device may include, but is not limited to, the following types of input devices or input and output devices or their combination: electronic whiteboards, whiteboards, projection keyboard devices, touch screens, touch pads, the other touch devices, electrical input devices, electromagnetic induction devices, pressure devices, infrared devices, laser devices, and mechanical devices.

8. The human computer interaction device according to claim 4, which is characterized in that:
the said auxiliary components adopt one of or a combination of the following forms: at least one track point, at least one scroll ball for controlling object's movement, at least one scroll wheel for controlling object's movement, at least one button for confirming an operation or operations, at least one touch device and at least one operating key which can work under the mouse function mode.

9. The human computer interaction device according to claim 1, which is characterized in that:
the said key input device is a keyboard; the said mouse simulation device comprises one main simulation device arranged on the left or right side of the said keyboard as well as certain keys arranged on the other side of the keyboard; the said certain keys can be set by selection to comprise one or more keys to which finger(s) will return after pressing a key or keys according to the standard fingering, and they are used to realize mouse's button function; or,
the said key input device is a keyboard; the said mouse simulation device comprises one main simulation device arranged on the said keyboard and certain keys arranged in the key region of the keyboard but out of the said main simulation device; among the said certain keys, the keys operated by left hand according to the standard fingering are used for realizing the function of mouse's left button, and the keys operated by right hand according to the standard fingering are used for realizing the function of mouse's right button;
the said main simulation device may include, but is not limited to, the following types of input devices or input and output devices or their combination: electronic whiteboards, whiteboards, projection keyboard devices, touch screens, touch pads, the other touch devices, electrical input devices, electromagnetic induction devices, pressure devices, infrared devices, laser devices, and mechanical devices.

10. The human computer interaction device according to claim 2, which is characterized in that:
the said key input device is a hard keyboard or a control panel; the said mouse simulation device is a hard device; in or near the key region of the said key input device, there are one or more hard control switches used for turning on or turning off the mouse function, or, on the said mouse simulation device, there are soft control switches used for turning on and turning off the mouse function; or,
the said key input device is a soft keyboard or a soft control panel displayed on the human computer interaction device; the said mouse simulation device is a soft device displayed on the human computer interaction device; on the said human computer interaction device, there are one or more hard control switches or soft control switches used for turning on or turning off the mouse function; the said human computer interaction device may include, but is not limited to, the following types of input devices or input and output devices or their combination: electronic whiteboards, whiteboards, projection keyboard devices, touch screens, the touch pads, other touch devices, electrical input devices, electromagnetic induction devices, pressure devices, infrared devices, and laser devices.

11. The human computer interaction device according to claim 2, which is characterized in that:
the said key input device is a soft device displayed on the said human computer interaction device; on the surface of the key region lies a key-shaped film, which is completely-transparent or between completely-transparent and completely-opacity, on which there are keyboard grooves with tactility; the said human computer interaction device may include, but is not limited to, one of or a combination of the following devices: electronic whiteboards, whiteboards, projection keyboard devices, touch screens, touch pads, the other touch devices, electrical input devices, electromagnetic induction devices, pressure devices, infrared devices, laser devices.

12. The human computer interaction device according to claim 3, which is characterized in that:
the said mouse simulation device includes one main simulation device; both of the said key input device and the said main simulation device are hard devices; the part of the said main simulation device in the key region of the said key input device consists of one or more small blocks of main simulation devices which agree with the keys of the said key input device in shape and size and are partitioned as per the normal boundary of a key position; further, in each small block of the main simulation device, there is a flexible mechanism which can be stretched and retracted or moved vertically; wherein the said main simulation device may include, but is not limited to, the following types of input devices or input and output devices or their combination: electronic whiteboards, whiteboards, projection keyboard devices, touch screens, touch pads, other touch devices, electrical input devices, electromagnetic induction devices, pressure devices, infrared devices, laser devices, and mechanical devices.

13. The human computer interaction device according to claim 3, which is characterized in that:
the said mouse simulation device includes a main simulation device which is partitioned into multiple regions in a formal, hidden, invisible or visible, implicit, explicit or displayed way, and the mouse function realized in each region may be different, and each of the said regions and their functions are fixed, variable or configurable; the said main simulation device may include, but is not limited to, the following types of devices or their combination: electronic whiteboards, whiteboards, projection keyboard devices, touch screens, touch pads, other touch devices, electrical input devices, electromagnetic induction devices, pressure devices, infrared devices, laser devices, and mechanical devices.

14. A kind of electronic device, which is characterized in that it includes the human computer interaction device said in claim 1.

15. The electronic devices according to claim 14, which is characterized in that:
the said human computer interaction device is an keyboard-type integrated keyboard and mouse simulation device of mobile phones, other hand-held devices or laptop computers, or a keyboard-type keyboard of desktop computers and a mouse simulation device set on the keyboard; or, the said human computer interaction device is a mouse simulation device which is set on the keyboard of the said electronic devices in a formal, hidden, invisible or visible, implicit, explicit or displayed way; or, the said human computer interaction device is a soft device which is set on the input and output device of the said electronic devices in a formal, hidden, invisible or visible, implicit, explicit or displayed way; the said input and output device may include, but is not limited to, the following types of input and output devices or their combination: electronic whiteboards, whiteboards, projection keyboard devices, touch screens, touch pads, other touch devices, electrical input devices, electromagnetic induction devices, pressure devices, infrared devices, and laser devices.

16. The electronic devices according to claim 14, which is characterized in that:
the said human computer interaction device is a soft device displayed on the input and output device included in the said electronic devices; by means of the control by hardware or software, the said input and output device can determine the content or device to be displayed in a certain region, including realizing the switchover among multiple display devices or displayed contents; the said input and output device may include, but is not limited to, the following types of input and output devices or their combination: electronic whiteboards, whiteboards, projection keyboard devices, touch screens, touch pads, other touch devices, electrical input devices, electromagnetic induction devices, pressure devices, infrared devices, and laser devices.

17. The human computer interaction device according to claim 14, which is characterized in that:
the said key input device is a soft device displayed or set on the said input and output device; the said mouse simulation device includes the touch pad or the other input and output device displayed or set on the said input and output device, the soft touch pad or other input and output devices displayed or set in the overlapping region when the mouse function is turned on, and the soft key input device displayed in the overlapping region when the mouse function is turned off; or
the said key input device and touch pad or other input and output devices are simultaneously displayed on an input and output device, wherein the display region of one device is completely transparent or is between completely-transparent and completely-opaque;
the said input and output device includes, but not limited to, the following types of devices or their combination: electronic whiteboards, whiteboards, projection keyboard devices, touch screens, touch pads, other touch devices, electrical input devices, electromagnetic induction devices, pressure devices, infrared devices, and the laser devices.

18. A human computer interaction method using the human computer interaction device said in claim 1, which is characterized in that:
during the process of inputting through a key input device, when needing to use the mouse function, one can turn on part of or the whole of the mouse function, and can choose to operate the mouse simulation device of which at least partial operating region is located within a key region or within the other input device, and in such a mode, when needing to switch to a key input mode or the other mode, one can choose turning off the said mouse function; wherein, the said key input device and/or the mouse simulation device includes, but not limited to, the following types of input or input and output devices or their combination, or the soft device realized on an input/output device: electronic whiteboards, whiteboards, projection keyboard devices, touch screens, touch pads, other touch devices, electrical input devices, electromagnetic induction devices, pressure devices, infrared devices, laser devices, and mechanical devices.

19. The human computer interaction methods according to claim 18, which is characterized in that:
the said mouse function can be realized by adopting one or more of the following methods:
Method A, when the mouse simulation device has a main simulation device, the mouse function can be realized separately through the operations on the said main simulation device;
Method B, when the mouse simulation device has a main simulation device, the mouse function can be realized through the operations on the said main simulation device and operating keys, and wherein the operating keys are used to realize part of or the whole of the button function of mouse;
Method C, when the mouse simulation device has a main simulation device and one or more auxiliary component(s) added and set on the keyboard, the mouse function can be realized through the operations on the said main simulation device and the auxiliary component(s);
Method D, when the mouse simulation device has multiple auxiliary components added and set on a keyboard, the mouse function can be realized through the operation(s) on the said auxiliary components.
Method E, when the mouse simulation device has multiple auxiliary components added and set on a keyboard, the mouse function can be realized through the operation(s) on the said auxiliary components and by means of an existing key or keys;
Method F, when the mouse simulation device has a main simulation device and one or more auxiliary components added and set on a keyboard, the mouse function can be realized through the operations on the said main simulation device as well as the auxiliary component(s) and an existing key or keys;
the said mouse function includes but is not limited to one or more of the following functions: executing, selecting, dragging, displaying menu, moving cursor, scrolling display screen, and multi-dimensional simultaneous moving display;
the said main simulation device includes but is not limited to the following types of input devices or input and output devices or their combination: electronic whiteboards, whiteboards, projection keyboard devices, touch screens, touch pads and other touch input devices, electrical input devices, electromagnetic induction devices, pressure devices, infrared devices, laser devices, and mechanical devices.

20. The human computer interaction methods according to claim 18, which is characterized in that:
the said mouse simulation device or the main simulation device thereof is partitioned into multiple regions in an implicit, explicit or displayed way, including the regions used for realizing the function of cursor movement, and at least one region used for realizing at least one of the following functions: executing, choosing, dragging, displaying menu, scrolling screen, and multi-dimensional simultaneous moving display; and each of the said regions and their functions are fixed, variable or configurable.

21. The human computer interaction methods according to claim 18, which is characterized in that:
the said mouse function is realized by one main simulation device arranged on the left or right side of the key region of the said key input device and certain keys arranged on the other side of the keyboard, and the said certain keys are one or more keys to which a finger or fingers will return after pressing a key or keys according to the standard fingering, and they are used to realize mouse's button function; or, the said mouse function is realized by a main simulation device, which is partially or completely arranged within the key region of the said key input device, and certain keys arranged outside the said main simulation device; among the said certain keys, the keys operated by left/right hand according to the standard fingering are used for realizing the function of mouse's left/right button, and the keys operated by right/left hand according to the standard fingering are used for realizing the function of mouse's right/left button.

22. The input methods according to claim 18, which is characterized in that:
the said auxiliary components at least include: one auxiliary component used for realizing the function of cursor movement and one auxiliary component used for realizing mouse's button function;
the said auxiliary components used for realizing mouse's movement function adopt one of or a combination of the following forms: at least one track point, at least one input device for controlling object's movement, at least one scroll ball for controlling object's movement, and at least one scroll wheel for controlling object's movement; and
the said auxiliary components used for realizing mouse's button function adopt one of or a combination of the following forms: at least one button for confirming operations, at least one track point, at least one scroll ball, at least one input device for controlling object's movement, at least one scroll wheel and at least one operating key which can work under a mouse function mode.

23. The input methods according to claim 18, which is characterized in that:
the said operations of turning on and turning off the mouse function are realized through one or more of the following methods:
turning on or turning off the mouse function by pressing or tapping the button(s) which is independently set on the keyboard for confirming operations;
turning on or turning off the mouse function by pressing or in sequence tapping the key combination(s) on the keyboard;
turning on or turning off the mouse function by touching the track point;
turning on or turning off the mouse function by turning one time the scroll ball;
turning on or turning off the mouse function by turning one time the scroll wheel;
turning off the mouse function when any input operation is received from the keyboard outside the operating region of the mouse simulation device;
turning off the mouse function when no operation is received from the mouse simulation device or the main simulation device thereof within the set time;
turning on or turning off the mouse function through finger's moving modes set on the mouse simulation device or the main simulation device thereof;
the said main simulation device may include, but is not limited to, the following types of input devices or input and output devices or their combination: electronic whiteboards, whiteboards, projection keyboard devices, touch screens, touch pads, other touch devices, electrical input devices, electromagnetic induction devices, pressure devices, infrared devices, laser devices, and mechanical devices.

24. The input methods according to claim 23, which is characterized in that:
when through the said moving modes that a finger or fingers set on the mouse simulation device or on the main simulation device thereof turn on or turn off a touch pad or the other device, the said moving modes include at least one of the followings:
the moving distance of finger(s) reaches or exceeds a set value;
the moving speed of finger(s) reaches or exceeds a set value;
the reciprocating frequency of finger's/fingers' movement reaches or exceeds a set value;
the pressure imposed by finger(s) on at least one key reaches or exceeds a set value;
a finger(s) moves or slides from the surface of one key to the surface of another key;
the moving track of finger(s) accords with a set shape;
a finger(s) clicks or double clicks the given point within a region, a certain region or the vertex of a certain region.

25. The input methods according to claim 19, which is characterized in that: the said main simulation device is to realize the mouse function as per the following methods:
after the said main simulation device is turned on, if there has been no slide or no click before, then the first click shall be regarded as clicking mouse's left button; and the first slide shall be regarded as controlling cursor's movement;
as clicking, if the most recent operation is a click or a slide, clicking the left side of the point of the last click or the final point of the last slide will be regarded as clicking mouse's left button and the function of clicking will be further maintained; clicking the right side of the point of the last click or the final point of the last slide will be regarded as clicking mouse's right button;
as clicking, if the most recent operation is a click or a slide, and a slide or a glide is started in the circle of which the center is at the point of the last click or the final point of the last glide and the radius is M, the slides or glides following it will be regarded as dragging until performing a new click or leaving the said main simulation device;
as gliding, if the most recent operation is a glide, gliding inside the region less than N away from the glide line and outside the circle of which the center is at the final point of the glide and the radium is M will be regarded as operating mouse's middle button;
the said M and N refers to a set distance.

26. The input method according to claim 19, which is characterized in that:
the said key input device is a soft device, and it can move with a cursor's movement or a finger's or fingers' movement; when the cursor or finger(s) moves from the present position towards a key or keys to be operated, the whole key input device or the part thereof that the finger(s) move(s) towards will move towards the finger(s) synchronously or asynchronously.

27. The input method according to claim 18, which is characterized in that:
the said mouse simulation device includes a main simulation device, and the region of the said main simulation device maps the whole or part of the screen; when a click is made on a certain point of the said main simulation device, the cursor will move to a point which is on the said screen and has mapping relation with the said point; meanwhile, when one unit is moved on the said main simulation device, the cursor will also move one unit on the said screen, or move multiple units as per the proportion in size between the said main simulation device and the said screen; the said main simulation device may include, but is not limited to, the following types of input devices or input and output devices or their combination: electronic whiteboards, whiteboards, projection keyboard devices, touch screens, touch pads, other touch input devices, electrical input devices, electromagnetic induction devices, pressure devices, infrared devices, laser devices, and mechanical devices.

28. The human computer interaction device according to claim 18, which is characterized in that:
when operating the said mouse simulation device, one can use a soft or hard nail, an artificial nail, a ring, a finger cap, a fingertip sheath, a finger article, a hand article or the other article as well as part of one of them and/or a combination of part of one of them to realize the positioning of the cursor or the displayed position.

29. The human computer interaction device according to claim 28, which is characterized in that:
as for the said articles used for the realization of positioning the cursor and the displayed position, their materials are: soft or hard metal, plastic, wooden products, biological products or the other soft or hard products.

30. The human computer interaction device according to claim 28, which is characterized in that:
as for the said articles used for the realization of positioning the cursor and the displayed position, their shape may be random, something having a cusp, sphere or oval sphere, or a polyhedron with 6, 8, 12 or 24 faces, or other curved surface, and part of one of them or a combination of part of one of them.

31. The human computer interaction device according to claim 28, which is characterized in that:
by moving the human body's certain points or parts felt or touched by the human body, the said mouse simulation device realizes the positioning and/or moving of the cursor or at least one of the followings relating to the cursor's formal, hidden, invisible or visible position, displacement or movement, or relating to the cursor's relative position: the formal, hidden, invisible or visible commands, command configurations, display modes, graphic representations, figures, images, command menu, buttons, keys or the commands or graphic representations which can be operated by clicks, the figures similar to the input and/or output devices, the human body's certain point or part which is felt or touched by the human body and which includes the touched centre point or the centre part of a finger or fingers; or an input operation is judged by the force, coverage or graphics of pressure.

32. The human computer interaction device according to claim 18, which is characterized in that:
when the said key input device and/or mouse simulation device is operated, shake, vibration, tingling, heat, twinkling and/or other feelings can be adopted to realize the hand-touch feeling and tactility.
